(19) United States
(12) Patent Application Publication
(10) Pub. No.: US 2026/0237759 A1
(43) Pub. Date: Aug. 13, 2026

(54) ANODE ASSEMBLY FOR A BATTERY CELL

(71) Applicant: ION STORAGE SYSTEMS, INC., Beltsville, MD (US)

(72) Inventors: Gregory Thomas Hitz, College Park, MD (US); Geoffrey Stephen Howard, Beltsville, MD (US); Ryan Gregory Naehr, Beltsville, MD (US)

(21) Appl. No.: 19/470,454

(22) PCT Filed: Mar. 29, 2024
(86) PCT No.: PCT/US2024/022368

§ 371 Date: Sep. 29, 2025

Related U.S. Application Data
(60) Provisional application No. 63/493,340, filed on Mar. 31, 2023.

(51) Int. Cl. H01M 10/42; H01M 4/02; H01M 4/04; H01M 4/58; H01M 10/0525; H01M 50/474; H01M 50/486

(52) U.S. Cl. CPC H01M 10/4235; H01M 4/043; H01M 4/5825; H01M 10/0525; H01M 50/474; H01M 50/486; H01M 2004/027

(57) ABSTRACT

The present disclosure provides an anode assembly for a battery cell. The anode assembly comprises a separator layer and an anode layer. The anode layer is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. And, an absolute pressure within the pores, Pₚₒᵣₑₛ, is less than an absolute pressure of an environment outside of the anode layer, Pₑₙᵥ. The present disclosure also provides methods of forming an anode assembly for a battery cell.

### CROSS REFERENCE TO RELATED APPLICATION

This PCT application claims the benefit of U.S. provisional application No. 63/493,340, filed Mar. 31, 2023. This document is hereby incorporated by reference in its entirety.

### FIELD OF THE INVENTION

The present invention relates to an anode assembly for a battery cell and methods of forming the same.

### BACKGROUND

Solid-state battery cells and hybrid solid-state battery cells may comprise one or more porous electrode layers. Such electrode layers are plated with, and stripped of, an electrode material (e.g., lithium metal) during charging and discharging of the battery cell. For example, an anode material may migrate to, and plate on, an anode layer from a cathode layer during charging of the battery cell. This plating of anode material results in the anode layer increasing in volume. Similarly, during stripping of the anode material (e.g., during discharge of the battery cell), the anode layer decreases in volume. In order to promote uniform plating of the anode material in the pores of the anode layer, and to prevent formation of pores within plated anode material, mechanical forces may be applied to one or more components of the battery cell. For example, an external force may be applied to the battery cell, or one or more components thereof, to compress the components of the battery cell. This approach necessitates an additional component that applies a mechanical force to one or more components of the battery cell, thereby decreasing specific and volumetric energy densities of the battery cell. Moreover, in battery applications where weight and/or space is limited, additional componentry may result in packaging/integration difficulties.

Accordingly, there remains a need to provide an improved anode assembly for a battery cell.

### SUMMARY OF THE INVENTION

In one aspect, the present invention provides an anode assembly for a battery cell. The anode assembly comprises a separator layer and an anode layer. The anode layer is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. And, an absolute pressure within the pores, Pₚₒᵣₑₛ, is less than an absolute pressure of an environment outside of the anode layer, Pₑₙᵥ.

In some embodiments, Pₚₒᵣₑₛ is less than about 101,325 Pa. For example, Pₚₒᵣₑₛ may be from about 1 Pa to about 101,324 Pa. In some embodiments, Pₚₒᵣₑₛ is from about 100 Pa to about 1,000 Pa. In other embodiments, Pₚₒᵣₑₛ is from about 1,000 Pa to about 10,000 Pa. In some embodiments, Pₚₒᵣₑₛ is from about 10,000 Pa to about 101,324 Pa. In other embodiments, Pₚₒᵣₑₛ is from about 100 Pa to about 2,000 Pa. In some embodiments, Pₚₒᵣₑₛ is from about 500 Pa to about 1,500 Pa. And, in some embodiments, Pₚₒᵣₑₛ is from about 750 Pa to about 1,250 Pa.

In some embodiments, a pressure differential between Pₚₒᵣₑₛ and Pₑₙᵥ is from about 100 Pa to about 100,000 Pa. In other embodiments, the pressure differential between Pₚₒᵣₑₛ and Pₑₙᵥ is from about 1,000 Pa to about 100,000 Pa. And, in some embodiments, the pressure differential between Pₚₒᵣₑₛ and Pₑₙᵥ is from about 10,000 Pa to about 100,000 Pa.

In some embodiments, the separator layer is substantially free of pores. In some embodiments, the separator layer comprises a SSE material. For example, the SSE material of the separator layer may comprise a polymer, a sulfide, an oxide, a chalcogenide, or any combination thereof. And, in some embodiments, the separator layer has a thickness of from about 1 μm to about 300 μm.

In some embodiments, the anode assembly further comprises an anode material disposed in at least a portion of the pores of the anode layer. For example, the anode material may comprise lithium metal, sodium metal, magnesium metal, or any combination thereof. And, in some embodiments, the anode material comprises lithium metal.

In some embodiments, the anode layer comprises a garnet material. In some embodiments, the anode layer has a thickness of from about 1 μm to about 500 μm.

In some embodiments, the anode current collector comprises a metal foil. For example, the metal foil may comprise copper, nickel, titanium, stainless steel, alloys thereof, or any combination thereof. And, in some embodiments, the metal foil has a tab configured to connect with an external circuit.

In some embodiments, the anode assembly is free of a component applying a substantial mechanical force on one or more of the anode layer, the separator layer, and the anode current collector.

In another aspect, the present inventions provides an anode assembly for a battery cell. The anode assembly comprises a separator, an anode layer, and a barrier. The anode layer is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The barrier is disposed about the outer surface of the anode layer and defines an interior and exterior. The barrier is impervious to liquid and gas. The anode layer is disposed in the interior of the barrier. And, an absolute pressure of the interior, Pᵢₙₜ, of the barrier is less than an absolute pressure of the exterior, Pₑₓₜ, of the barrier.

In some embodiments, Pᵢₙₜ of the barrier is less than about 101,325 Pa. For example, Pᵢₙₜ of the barrier may be from about 1 Pa to about 101,324 Pa. In some embodiments, Pᵢₙₜ of the barrier is from about 100 Pa to about 1,000 Pa. In other embodiments, Pᵢₙₜ of the barrier is from about 1,000 Pa to about 10,000 Pa. In some embodiments, Pᵢₙₜ of the barrier is from about 10,000 Pa to about 101,324 Pa. In other embodiments, Pᵢₙₜ of the barrier is from about 100 Pa to about 2,000 Pa. In some embodiments, Pᵢₙₜ of the barrier is from about 500 Pa to about 1,500 Pa. And, in some embodiments, Pᵢₙₜ of the barrier is from about 750 Pa to about 1,250 Pa.

In some embodiments, a pressure differential between Pᵢₙₜ and Pₑₓₜ of the barrier is from about 100 Pa to about 100,000 Pa. In some embodiments, the pressure differential between Pᵢₙₜ and Pₑₓₜ of the barrier is from about 1,000 Pa to about 100,000 Pa. And, in some embodiments, the pressure differential between Pᵢₙₜ and Pₑₓₜ of the barrier is from about 10,000 Pa to about 100,000 Pa.

In some embodiments, the separator layer is disposed in the interior of the barrier. In some embodiments, the separator layer is substantially free of pores. In some embodiments, the separator layer comprises a SSE material. For example, the SSE material of the separator layer may comprise a polymer, a sulfide, an oxide, a chalcogenide, or any combination thereof. And, in some embodiments, the separator layer has a thickness of from about 1 μm to about 300 μm.

In some embodiments, the anode layer further comprises an anode material disposed in at least a portion of the pores of the anode layer. In other embodiments, the anode material comprises lithium metal, sodium metal, magnesium metal, or any combination thereof. For example, the anode material may comprise lithium.

In some embodiments, the anode layer comprises a garnet material. And, in some embodiments, the anode layer has a thickness of from about 1 μm to about 500 μm.

In some embodiments, the anode assembly further comprises an anode current collector coupled to the second surface of the anode layer. In some embodiments, the anode current collector is disposed in the interior of the barrier. In some embodiments, the anode current collector comprises a metal foil. In some embodiments, the anode current collector comprises a metal foil. For example, the metal foil may comprise copper, nickel, titanium, stainless steel, alloys thereof, or any combination thereof. And, in some embodiments, the metal foil has a tab configured to connect with an external circuit.

In some embodiments, the barrier is a seal comprising a sealant material. In some embodiments, the seal is at least partially disposed on the anode current collector. In other embodiments, the seal is at least partially disposed on the outer surface of the anode layer. And, in some embodiments, the seal is at least partially disposed on the separator layer.

In some embodiments, the separator layer has a front surface facing the anode layer, a back surface facing away from the anode layer, and an outer surface extending from the front surface to the back surface. In such embodiments, the seal may be at least partially disposed on the outer surface of the separator layer.

In some embodiments, the separator layer defines a recess, and the seal is disposed in the recess.

In some embodiments, the anode layer defines a first porous region between a center and the outer surface of the anode layer and a second porous region between the first porous region and the outer surface of the anode layer. In such embodiments, the pores for the first porous region may be substantially free of the sealant material. In some embodiments, at least a portion of the pores of the second porous region comprise the sealant material.

In some embodiments, the anode layer further comprises an anode current collector coupled to the second surface of the anode layer. The separator layer has a front surface facing the anode layer, a back surface facing away from the anode layer, and an outer surface extending from the front surface to the back surface. The anode current collector has an interior surface facing the anode layer, an exterior surface facing away from the anode layer, and an outer surface extending from the interior surface to the exterior surface. And, the seal is at least partially disposed on each of the outer surface of the anode layer, the outer surface of the separator layer, and the outer surface of the anode current collector.

In some embodiments, the sealant material comprises a non-conductive polymer, a non-conductive glass, or any combination thereof. In other embodiments, the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. And, in some embodiments, at least a portion of the seal has a thickness of from about 1 μm to about 50 μm.

In some embodiments, the anode assembly is free of a component applying a substantial mechanical force on one or more of the anode layer, the separator layer, the seal, and the anode current collector.

In another aspect, the present invention provides a battery cell. The battery cell comprises an anode assembly, an anode current collector, a cathode layer, and a cathode current collector. The anode assembly may be any anode assembly described herein. The anode current collector is coupled to the second surface of the anode layer. The cathode layer is at least partially disposed on the separator layer. The cathode layer has a first surface facing the separator layer, a second surface facing away from the separator layer, and an outer surface extending from the first surface to the second surface. The cathode current collector is coupled to the second surface of the cathode layer.

In some embodiments, the battery cell further comprises a housing having a plurality of interior walls defining an interior, wherein the anode assembly, anode current collector, cathode layer, and cathode current collector are disposed in the interior of the housing. In some embodiments, the battery cell further comprises a catholyte disposed in the cathode layer. And, in some embodiments, the battery cell is free of a component applying a substantial mechanical force on one or more of the anode layer, the separator layer, the seal, the anode current collector, the cathode layer, and the cathode current collector.

In another aspect, the present invention provides methods of forming the anode assembly described herein.

### BRIEF DESCRIPTION OF THE DRAWINGS

The figures below are provided by way of example and are not intended to limit the scope of the claimed invention.

FIG. 1 is a side view of a first exemplary embodiment of an anode assembly.

FIG. 2A is a cross-sectional view of a second exemplary embodiment of an anode assembly for a battery cell.

FIG. 2B is a front view of the anode assembly of FIG. 2A.

FIG. 3A is a cross-sectional view of a third exemplary embodiment of an anode assembly for a battery cell.

FIG. 3B is a close-up view of a portion of the anode assembly of FIG. 3A according to one embodiment.

FIG. 3C is a close-up view of a portion of the anode assembly of FIG. 3A according to another embodiment.

FIG. 3D is a close-up view of a portion of the anode assembly of FIG. 3A according to a further embodiment.

FIG. 3E is a close-up view of a portion of the anode assembly of FIG. 3A according to yet another embodiment.

FIG. 4A is a cross-sectional view of a fourth exemplary embodiment of an anode assembly for a battery cell.

FIG. 4B is a front view of the anode assembly of FIG. 4A.

FIG. 5A is a cross-sectional view of a fifth exemplary embodiment of an anode assembly for a battery cell.

FIG. 5B is a cross-sectional view of a sixth exemplary embodiment of an anode assembly for a battery cell.

FIG. 6A is a cross-sectional view of a seventh exemplary embodiment of an anode assembly for a battery cell.

FIG. 6B is a front view of the anode assembly of FIG. 6A.

FIG. 7A is a cross-sectional view of an eighth exemplary embodiment of an anode assembly for a battery cell.

FIG. 7B is a front view of the anode assembly of FIG. 7A.

FIG. 8A is a cross-sectional view of a first exemplary embodiment of a battery cell.

FIG. 8B is a front view of the battery cell of FIG. 8A.

FIG. 8C is a cross-sectional view of a second exemplary embodiment of a battery cell.

FIG. 8D is a front view of the battery cell of FIG. 8C.

FIG. 9A is a cross-sectional view of a third exemplary embodiment of a battery cell.

FIG. 9B is a front view of the battery cell of FIG. 9A.

FIG. 9C is a cross-sectional view of a fourth exemplary embodiment of a battery cell.

FIG. 9D is a front view of the battery cell of FIG. 9C.

FIG. 10A is a cross-sectional view of a fifth exemplary embodiment of a battery cell.

FIG. 10B is a front view of the battery cell of FIG. 10A.

FIG. 10C is a cross-sectional view of a sixth exemplary embodiment of a battery cell.

FIG. 10D is a front view of the battery cell of FIG. 10C.

FIG. 11 is a flow chart of a method of forming an anode assembly according to one implementation of the invention.

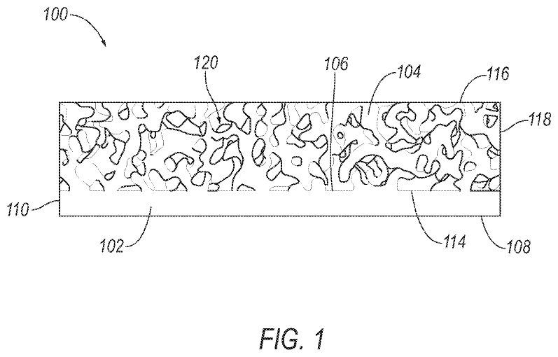

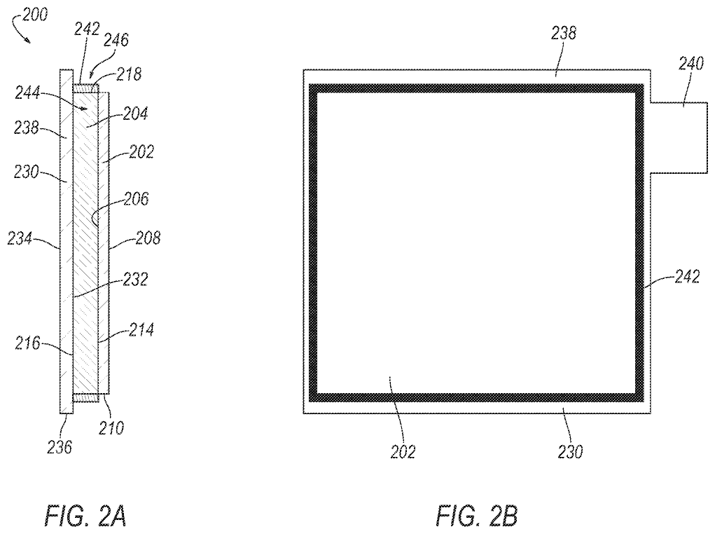

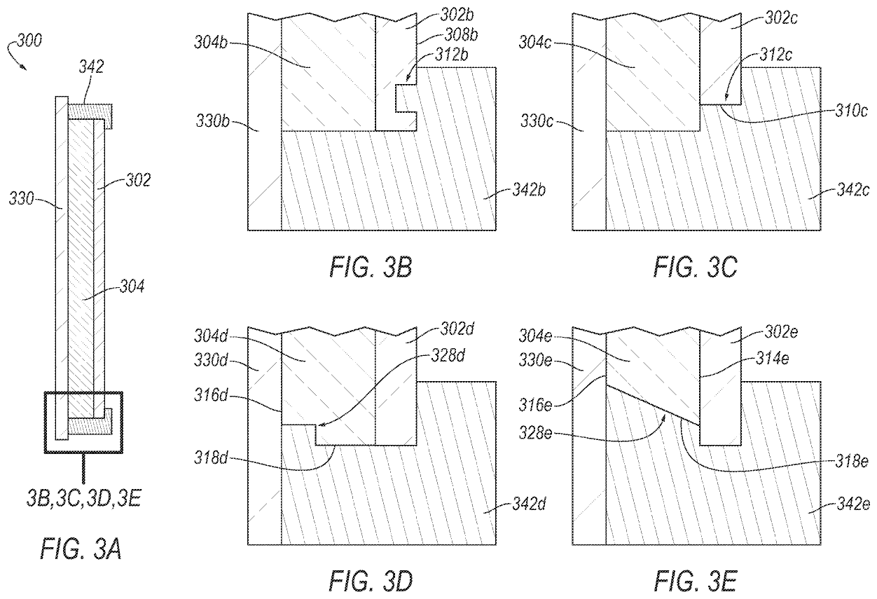

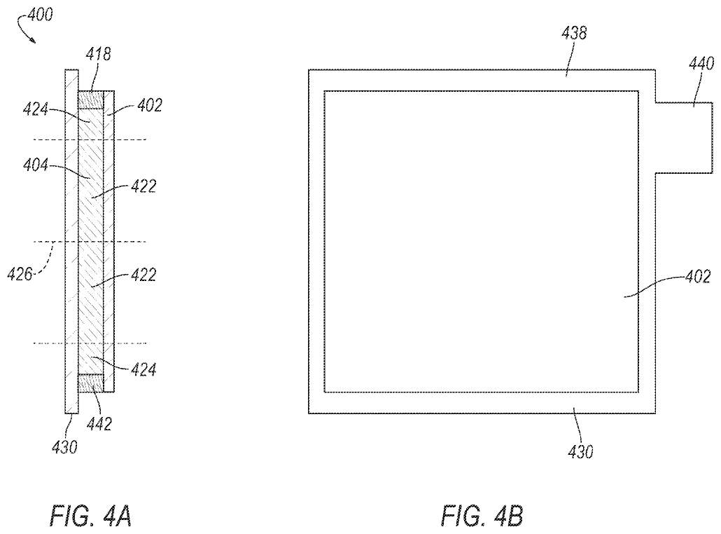

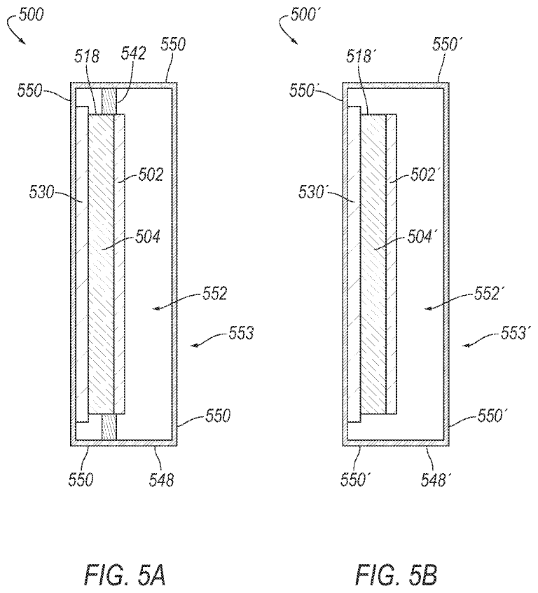

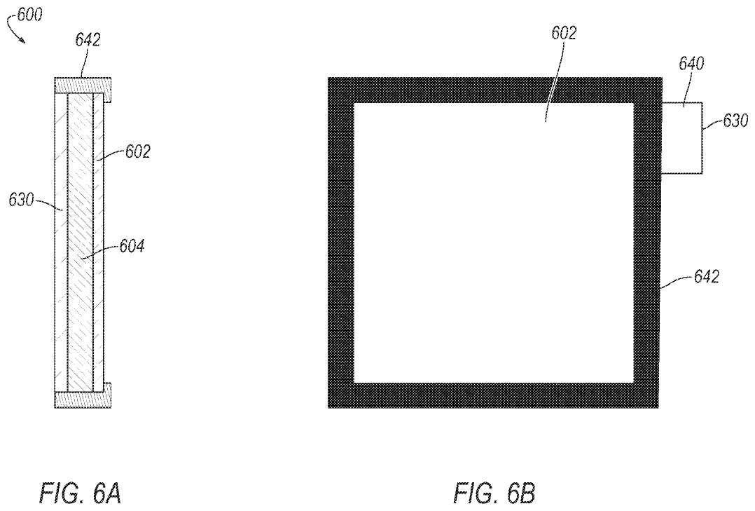

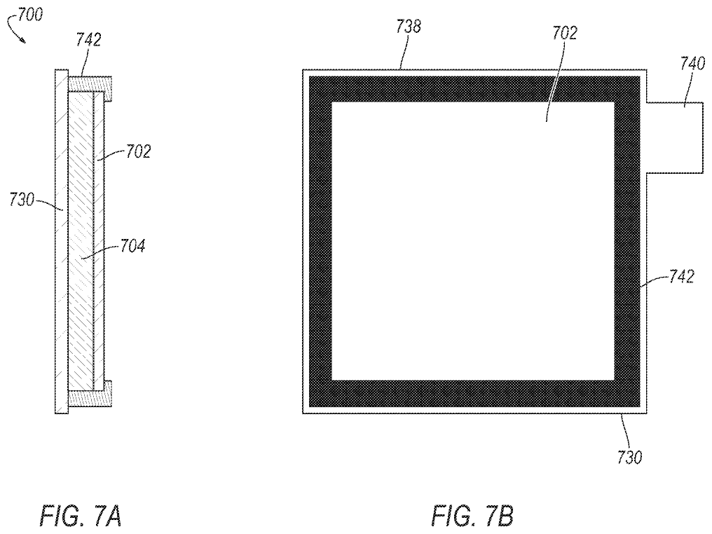

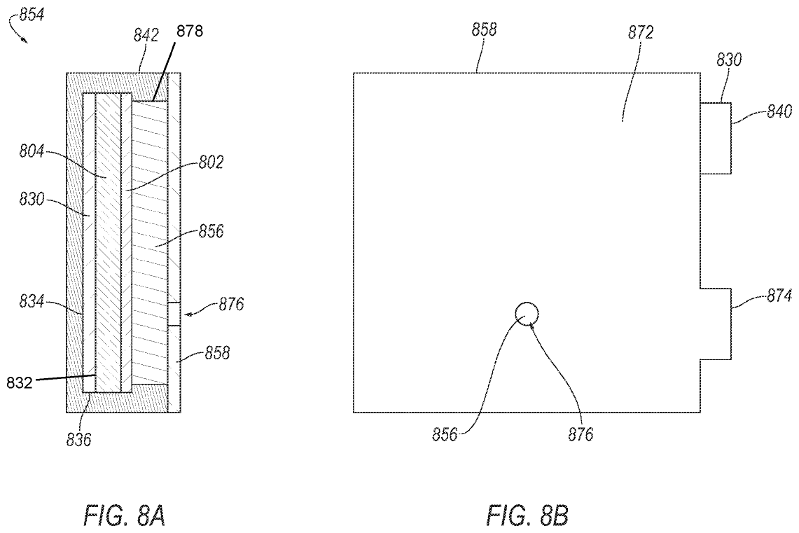

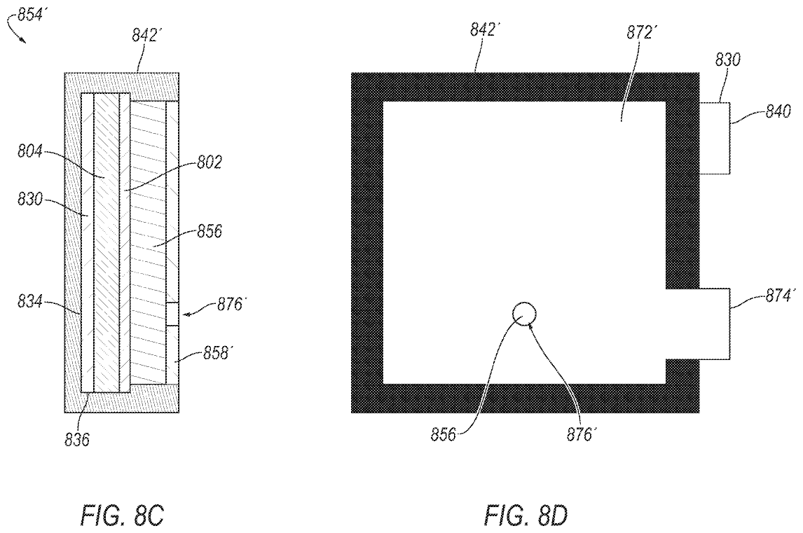

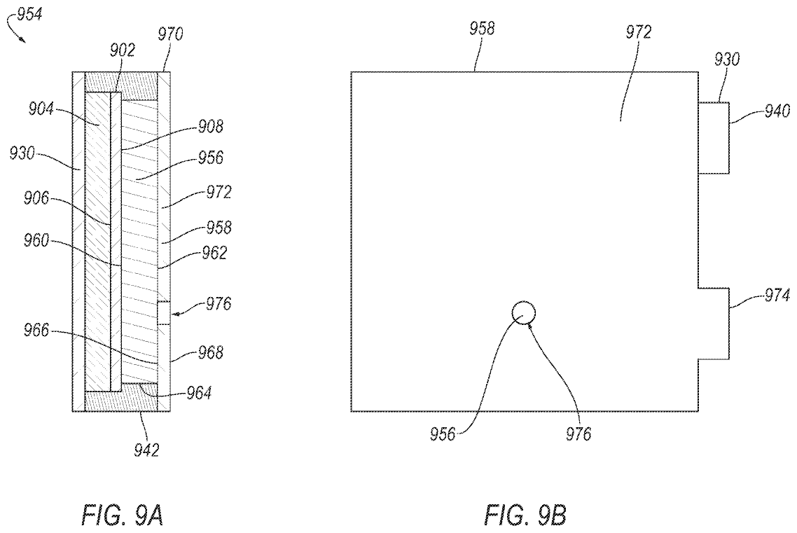

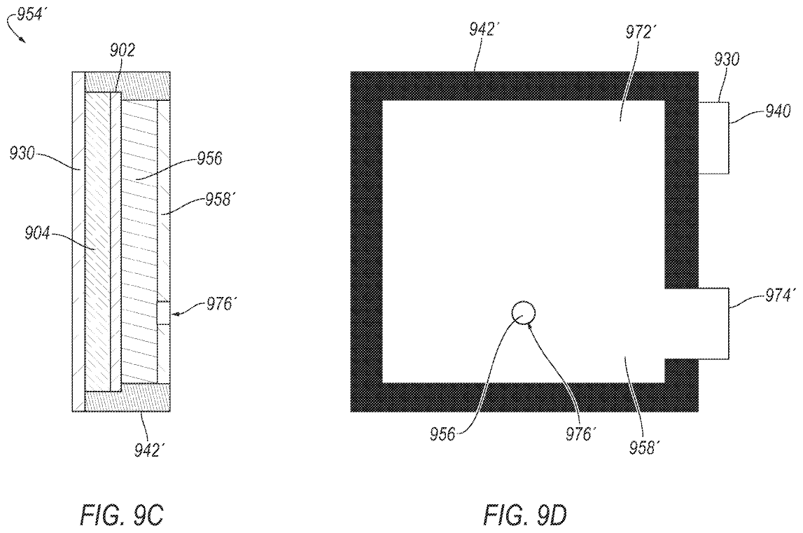

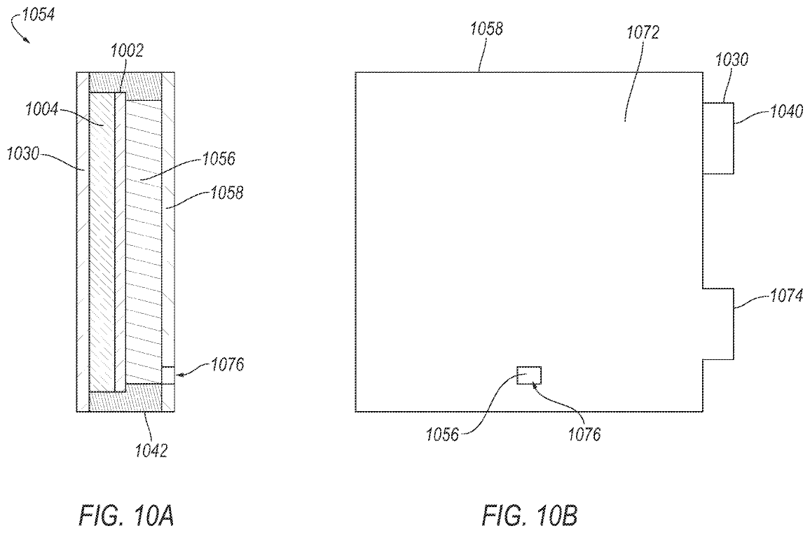

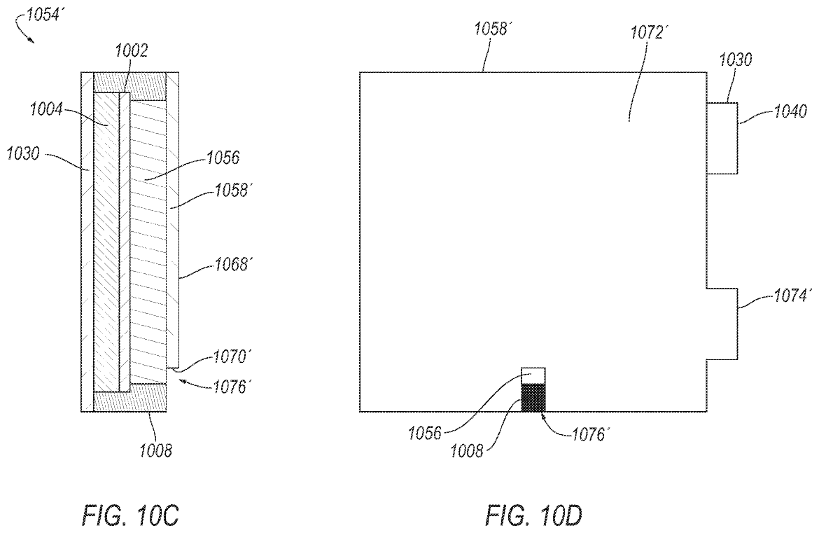

Like reference numerals in the various drawings indicate like elements. For example, the separator layer may be referred to as 102 in FIG. 1, as 602 in FIG. 6A, and 802 FIG. 8A. In other examples, the anode assembly may be referred to as 100 in FIG. 1, as 200 in FIG. 2, as 600 in FIG. 6A, as 700 in FIG. 7, and as 900 in FIG. 9. In other examples, the anode layer may be referred to as 104 in FIG. 1, 204 in FIG. 2, 304 in FIG. 3, 404 in FIG. 4, 504 in FIG. 5, 604 in FIG. 6, 704 in FIG. 7, 804 in FIG. 8, 904 in FIG. 9, and 1004 in FIG. 10. In other examples, the front surface of the separator layer may be referred to as 106 in FIG. 1, 2046 in FIG. 2, 306 in FIG. 3, 406 in FIG. 4, 506 in FIG. 5, 606 in FIG. 6, 706 in FIG. 7, 806 in FIG. 8, 906 in FIG. 9, and 1006 in FIG. 10. In other examples, the back surface of the separator layer may be referred to as 108 in FIG. 1, 208 in FIG. 2, 308 in FIG. 3, and 908 in FIG. 9. In other examples, the separator outer surface may be referred to as 110 in FIG. 1, 210 in FIG. and 310 in FIG. 3. In other examples, the outer surface of the anode layer may be referred to as 118 in FIG. 1, 218 in FIG. 2, 318 in FIG. 3, and 518 in FIG. 5. In other examples, the first surface of the anode layer may be referred to as 114 in FIG. 1, 214 in FIG. 2, and 314 in FIG. 3. In other examples, the second surface of the anode layer may be referred to as 116 in FIG. 1, and 316 in FIG. 3. In other examples, a seal may be referred to as 242 in FIG. 2, 342 in FIG. 3, 442 in FIG. 4, 542 in FIG. 5, 642 in FIG. 6, 742 in FIG. 7, 842 in FIG. 8, 942 in FIG. 9, and 1042 in FIG. 10. In other examples, an anode current collector may be referred to as 230 in FIG. 2, 330 in FIG. 3, 430 in FIG. 4, 530 in FIG. 5, 630 in FIG. 6, 730 in FIG. 7, 830 in FIG. 8, 930 in FIG. 9, and 1030 in FIG. 10. In other examples, a tab may be referred to as 240 in FIG. 2, 340 in FIG. 3, 440 in FIG. 4, 540 in FIG. 5, 640 in FIG. 6, 740 in FIG. 7, 840 in FIG. 8, 940 in FIG. 9, and 1040 in FIG. 10.

### DETAILED DESCRIPTION

The present invention provides an anode assembly for a battery call, a battery cell comprising such an anode assembly, and methods of forming such an anode assembly.

As used herein, the following definitions shall apply unless otherwise indicated.

### I. DEFINITIONS

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on,” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “battery cell” refers to a rechargeable secondary cell. In some embodiments, the battery cell may be a solid-state lithium-ion battery cell.

As used herein, the term “anode assembly” refers to an assembly comprising a separator layer and an anode layer.

As used herein, the term “separator layer” refers to a layer disposed between an anode layer and a cathode layer in a battery cell and that permits cations (e.g., lithium cations) to flow between the anode and cathode layers. In some embodiments, the separator layer is substantially free of pores (e.g., having an apparent porosity of less than 50%, having an apparent porosity of less than 40%, having an apparent porosity of less than 30%, having an apparent porosity of less than 20%, having an apparent porosity of less than 15%, having an apparent porosity of less than 10%, having an apparent porosity of less than 5%, or having an apparent porosity of less than 1%). And, in some embodiments, the separator layer is free of pores.

As used herein, the term “anode layer” refers to a negative electrode layer from which electrons flow during the discharging phase of a battery cell. The anode layer is at least partially disposed on the separator layer and has a first surface facing the separator layer and a second surface facing away from the separator layer. The anode layer comprises a solid-state electrolyte (SSE) material defining pores adapted to receive an anode material. In some embodiments, an absolute pressure within the pores, Pₚₒᵣₑₛ, is less than an absolute pressure of an environment outside of the anode layer, Pₑₙᵥ. In other embodiments, when the anode layer is disposed in an interior of a barrier, Pₚₒᵣₑₛ is substantially the same as an absolute pressure of the interior of the barrier, Pᵢₙₜ.

As used herein, the term “environment outside of the anode layer” refers to an environment having an absolute pressure that is greater than Pₚₒᵣₑₛ and that is separated from the anode layer by one or more barriers that are impervious to liquid and gas. For example, when the anode layer is disposed in a seal, the environment outside of the anode layer refers to the environment outside of the seal. In other embodiments, when the anode layer is disposed in a housing, the environment outside of the anode layer refers to the environment outside of the housing. In some embodiments, Pₑₙᵥ is from about 90,000 Pa to about 110,000 Pa.

As used herein, the term “bi-layer” refers to the anode layer disposed on the separator layer.

As used herein, the term “anode current collector” refers to a current collector coupled to the anode layer. The anode current collector is configured to be electrically coupled to the anode layer during operation of the battery cell (e.g., charging and/or discharging of the battery cell). In some embodiments, the anode current collector comprises a metal foil. In other embodiments, the anode current collector comprises a tab configured to connect with an external circuit.

As used herein, the term “cathode layer” refers to a positive electrode layer into which electrons flow during the discharging phase of the battery cell.

As used herein, the term “cathode current collector” refers to a current collector coupled to the cathode layer. The cathode current collector is configured to be electrically coupled to the cathode layer during operation of the battery cell (e.g., charging and/or discharging of the battery cell). In some embodiments, the cathode current collector comprises a metal foil. In other embodiments, the cathode current collector comprises a tab configured to connect with an external circuit.

As used herein, the term “barrier” refers to a component disposed about the anode layer and that defines an interior and an exterior. The anode layer is disposed in the interior of the barrier. The barrier is impervious to liquid and gas, thereby preventing flow of liquid and gas into, or out of, the anode layer. An absolute pressure of the interior, Pᵢₙₜ, of the barrier is less than an absolute pressure of the exterior, Pₑₓₜ, of the barrier. In some embodiments, the barrier is a seal. In other embodiments, the barrier is a housing.

As used herein, the term “seal” refers to a layer disposed about the anode layer and that defines an interior and an exterior. The anode layer is disposed in the interior of the seal. The seal comprises a sealant material. In some embodiments, when the barrier is the seal, the seal is impervious to liquid and gas, thereby preventing flow of liquid and gas into, or out of, the anode layer. In some embodiments, an absolute pressure of the interior, Pᵢₙₜ, of the seal is less than an absolute pressure of the exterior, Pₑₓₜ, of the seal. In other embodiments, the seal is substantially impervious to liquid and pervious to gas.

As used herein, the term “apparent porosity” refers to the open (or accessible) porosity (i.e., porosity that excludes volume(s) from sealed or closed pores, cells, or voids). Apparent porosity can be represented as a fraction or percentage of the volume of open pores, cells, or voids over the total volume.

As used herein, the term “component applying a substantial mechanical force” refers to a component of an anode assembly and/or battery cell having a primary function of applying a mechanical force to one or more components of the anode assembly and/or battery cell in order to promote uniform plating of an anode material in the pores of the anode layer and/or to prevent formation of pores within plated anode material (e.g., lithium metal).

### II. ANODE ASSEMBLY

In one aspect, the present invention provides an anode assembly for a battery cell.

As shown in FIG. 1, the anode assembly 100 comprises a separator layer 102, an anode layer 104.

### A. Separator Layer

The separator layer may be comprised of any suitable material that permits cations (e.g., lithium cations) to flow between anode and cathode layers during operation of a battery cell. In some embodiments, the separator layer comprises a solid-state electrolyte (SSE) material. For example, the SSE material of the separator layer may comprise a polymer, a sulfide, an oxide, a chalcogenide, or any combination thereof. For example, the SSE material may comprise a sulfide. In some embodiments, the SSE material comprises LSS, LTS, LXPS, LXPSO, LATS, lithium garnets, or any combination thereof, wherein X is Si, Ge, Sn, As, Al, or any combination thereof, wherein Sis S, Si, or any combination thereof, and wherein T is Sn.

As used herein, “LSS” refers to lithium silicon sulfide which can be described as Li₂S—SiS₂, Li—SiS₂, Li—S—Si, or a SSE material comprising Li, S, and Si. In some embodiments, LSS comprise LiₓSi_{y}S_{z}, wherein 0.33≤x≤0.5, 0.1≤y≤0.2, and 0.4≤z≤0.55. In some embodiments, LSS may comprise up to 10 atomic % oxygen. In other embodiments, LSS may comprise a SSE material comprising Li, Si, and S. In some embodiments, LSS comprises a mixture of Li₂S and SiS₂. In some embodiments, a molar ratio of Li₂S:SiS₂ is 90:10, 85:15, 80:20, 75:25, 70:30, 2:1, 65:35, 60:40, 55:45, or 50:50. In some embodiments, LSS may further comprise a doped compound such as LiₓPO_{y}, LiₓBO_{y}, Li₄SiO₄, Li₃MO₄, Li₃MO₃, PS, and/or lithium halides such as, but not limited to, LiI, LiCl, LiF, or LiBr, wherein 0<x≤5 and 0<y≤5.

As used herein, “LTS” refers to a lithium tin sulfide compound which can be described as Li₂S—SnS₂, Li₂S—SnS, Li—S—Sn, or an SSE material comprising Li, S, and Sn. In some embodiments, LTS may comprise LiₓSn_{y}S_{z}, wherein 0.25≤x≤0.65, 0.05≤y≤0.2, and 0.25≤z≤0.65. In some embodiments, LTS may comprise a mixture of Li₂S and SnS₂ in a molar ratio (i.e., Li₂S:SnS₂) of 80:20, 75:25, 70:30, 2:1, or 1:1. In some embodiments, LTS may comprise up to 10 atomic % oxygen. In other embodiments, LTS may be doped with Bi, Sb, As, P, B, Al, Ge, Ga, In, or any combination thereof. As used herein, “LATS” refers to LTS, as used above, and further comprising Arsenic (As).

As used herein, “LXPS” refers to a material characterized by the formula LiₐMP_{b}S_{c}, wherein Mis Si, Ge, Sn, Al, or any combination thereof, and wherein 2≤a≤8, 0.5≤b≤2.5, and 4≤c≤12. “LSPS” refers to an electrolyte material characterized by the formula LₐSiP_{b}S_{c}, where 2≤a≤8, 0.5≤b≤2.5, 4≤c≤12.

When Mis Sn and Si (i.e., both Sn and Si are present), the LXPS material is referred to as “LSTPS”. As used herein, “LSTPSO” refers to LSTPS that is doped with, or has, O present. In some embodiments, “LSTPSO” is a LSTPS material with an oxygen content between 0.01 and 10 atomic %. As used herein, “LSPS” refers to an electrolyte material having Li, Si, P, and S chemical constituents. As used herein “LSTPS,” refers to an electrolyte material having Li, Si, P, Sn, and S chemical constituents. As used herein, “LSPSO,” refers to LSPS that is doped with, or has, O present. In some embodiments, “LSPSO” is an LSPS material with an oxygen content between 0.01 and 10 atomic %. As used herein, “LATP” refers to an electrolyte material having Li, As, Sn, and P chemical constituents. As used herein “LAGP” refers to an electrolyte material having Li, As, Ge, and P chemical constituents. As used herein, “LXPSO” refers to an electrolyte material comprising LiₐMP_{b}S_{c}O_{d}, wherein Mis Si, Ge, Sn, Al, or any combination thereof, and wherein 2≤a≤8, 0.5≤b≤2.5, 4≤c≤12, and d<3. LXPSO refers to LXPS, as defined above, and having oxygen doping at from 0.1 to about 10 atomic %. As used herein, “LPS” refers to an electrolyte material comprises Li₂S—P₂S₅. As used herein, “LPSO” refers to LPS, as defined herein, and further comprising oxygen doping at from 0.1 to about 10 atomic %.

In some embodiments, the SSE material of the separator layer comprises a polymer. For example, the polymer may comprise polyolefins, natural rubbers, synthetic rubbers, polybutadiene, polyisoprene, epoxidized natural rubber, polyisobutylene, polypropylene oxide, polyacrylates, polymethacrylates, polyesters, polyvinyl esters, polyurethanes, styrenic polymers, epoxy resins, epoxy polymers, poly(bisphenol A-co-epichlorohydrin), vinyl polymers, polyvinyl halides, polyvinyl alcohol, polyethyleneimine, poly(maleic anhydride), silicone polymers, siloxane polymers, polyacrylonitrile, polyacrylamide, polychloroprene, polyvinylidene fluoride, polyvinyl pyrrolidone, polyepichlorohydrin, blends thereof, or copolymers thereof. In some embodiments, the polymer is polyolefins. In some embodiments, the polymer is natural rubbers. In some embodiments, the polymer is synthetic rubbers. In some embodiments, the polymer is polybutadiene. In some embodiments, the polymer is polyisoprene. In some embodiments, the polymer is epoxidized natural rubber. In other embodiments, the polymer is polyisobutylene. In some embodiments, the polymer is polypropylene oxide. In some embodiments, the polymer is polyacrylates. In some embodiments, the polymer is polymethacrylates. In some embodiments, the polymer is polyesters. In other embodiments, the polymer is polyvinyl esters. In some embodiments, the polymer is polyurethanes. In some embodiments, the polymer is styrenic polymers. In some embodiments, the polymer is epoxy resins. In some embodiments, the polymer is epoxy polymers. In some embodiments, the polymer is poly(bisphenol A-co-epichlorohydrin). In some embodiments, the polymer is vinyl polymers. In some embodiments, the polymer is polyvinyl halides. In some embodiments, the polymer is polyvinyl alcohol. In some embodiments, the polymer is polyethyleneimine. In other embodiments, the polymer is poly(maleic anhydride). In some embodiments, the polymer is silicone polymers. In some embodiments, the polymer is siloxane polymers. In some embodiments, the polymer is polyacrylonitrile. In some embodiments, the polymer is polyacrylamide. In some embodiments, the polymer is polychloroprene. In some embodiments, the polymer is polyvinylidene fluoride. In some embodiments, the polymer is polyvinyl pyrrolidone. In some embodiments, the polymer is polyepichlorohydrin. In some embodiments, a molecular weight of the polymer is greater than about 50,000 g/mol.

In some embodiments, the polymer is preformed and selected from the group consisting of polypropylene, polyethylene, polybutadiene, polyisoprene, epoxidized natural rubber, poly(butadiene-co-acrylonitrile), polyethyleneimine, polydimethylsiloxane, and poly(ethylene-co-vinyl acetate). In other embodiments, a molecular weight of the polymer is greater than about 50,000 g/mol.

When the SSE material comprises a polymer, the SSE material may further comprise a metal salt (e.g., a lithium salt (e.g., LiPF₆)).

In some embodiments, the SSE material of the separator layer comprises a lithium perovskite material, Li₃N, Li-β-alumina, Lithium Super-ionic Conductors (LISICON), Li_{2.88}PO_{3.86}N_{0.14} (LiPON), Li₉AlSiO₈, Li₁₀GeP₂S₁₂, lithium garnet SSE materials, doped lithium garnet SSE materials, lithium garnet composite materials, or any combination thereof. In various embodiments, the lithium garnet SSE material is cation-doped Li₅La₃M¹₂O₁₂, where M¹ is Nb, Zr, Ta, or any combination thereof, cation-doped Li₆La₂BaTa₂O₁₂, cation-doped Li₇La₃Zr₂O₁₂, and cation-doped Li₆BaY₂M¹₂O₁₂, where cation dopants are barium, yttrium, zinc, or combinations thereof, and the like. In various other embodiments, the lithium garnet SSE material is Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, Li_{6.75}BaLa₂Ta_{1.75}Zn_{0.25}O₁₂, or any combination thereof.

In some embodiments, the SSE material of the separator layer and the SSE material of the anode layer are the same (e.g., the SSE material of the separator layer may be any SSE material described herein for the anode layer). In other embodiments, the SSE material of the separator layer and the SSE material of the separator layer are different.

In some embodiments, the separator layer is substantially free of pores (e.g., having an apparent porosity of less than 50%, having an apparent porosity of less than 40%, having an apparent porosity of less than 30%, having an apparent porosity of less than 20%, having an apparent porosity of less than 15%, having an apparent porosity of less than 10%, having an apparent porosity of less than 5%, or having an apparent porosity of less than 1%). And, in some embodiments, the separator layer is free of pores.

In some embodiments, the separator layer has a thickness of from about 1 μm to about 300 μm. In some embodiments, the separator layer has a thickness of from about 1 μm to about 200 μm. In other embodiments, the separator layer has a thickness of from about 1 μm to about 100 μm. In some embodiments, the separator layer has a thickness of from about 1 μm to about 50 μm. In some embodiments, the separator layer has a thickness of from about 1 μm to about 20 μm. And, in some embodiments, the separator layer has a thickness of from about 1 μm to about 10 μm.

With reference again to FIG. 1, the separator layer has a front surface 106 facing the anode layer 104, a back surface 108 facing away from the anode layer 104 and an outer surface 110 extending from the front surface 106 to the back surface 108.

In some embodiments, the separator layer may define a recess 312b, 312c, as shown in FIGS. 3B and 3C. The recess 312b, 312c of the separator layer 302d, 302c may be defined by the front surface, back surface 308b and/or the outer surface 310c of the separator layer 302c, 302d. For example, the back surface 308b of the separator layer 302c, 302d may define the recess 312b, 312c, as shown in FIG. 3B. In other embodiments, the back surface 308b and the outer surface 310c of the separator layer 302c, 302d define the recess 312b, 312c, as shown in FIG. 3C.

### B. Anode Layer

With reference again to FIG. 1, the anode layer 104 is at least partially disposed on the separator layer 102. In some embodiments, the anode layer 104 has a first surface 114 facing the separator layer 104, a second surface 116 facing away from the separator layer 104, and an outer surface 118 extending from the first surface 114 to the second surface 116. The anode layer 104 comprises an SSE material defining pores 120 adapted to receive an anode material, as shown in FIG. 1.

An absolute pressure within the pores, Pₚₒᵣₑₛ, of the anode layer is less than an absolute pressure of an environment outside of the anode layer, Pₑₙᵥ. As described herein, the term “environment outside of the anode layer” refers to an environment having an absolute pressure that is greater than Pₚₒᵣₑₛ and that is separated from the anode layer by one or more barriers (e.g., a seal, a housing, etc.) that are impervious to liquid and gas.

In some embodiments, Pₚₒᵣₑₛ is less than about 101,325 Pa. For example, Pₚₒᵣₑₛ may be from about 1 Pa to about 101,324 Pa. In some embodiments, Pₚₒᵣₑₛ is from about 100 Pa to about 1,000 Pa. In some embodiments, Pₚₒᵣₑₛ is from about 100 Pa to about 200 Pa. In other embodiments, Pₚₒᵣₑₛ is from about 200 Pa to about 300 Pa. In some embodiments, Pₚₒᵣₑₛ is from about 300 Pa to about 400 Pa. In some embodiments, Pₚₒᵣₑₛ is from about 400 Pa to about 500 Pa. In other embodiments, Pₚₒᵣₑₛ is from about 500 Pa to about 600 Pa. In some embodiments, Pₚₒᵣₑₛ is from about 600 Pa to about 700 Pa. In other embodiments, Pₚₒᵣₑₛ is from about 700 Pa to about 800 Pa. In some embodiments, Pₚₒᵣₑₛ is from about 800 Pa to about 900 Pa. In some embodiments, Pₚₒᵣₑₛ is from about 900 Pa to about 1,000 Pa. In some embodiments, Pₚₒᵣₑₛ is from about 100 Pa to about 500 Pa. In some embodiments, Pₚₒᵣₑₛ is from about 500 Pa to about 1,000 Pa. And, in some embodiments, Pₚₒᵣₑₛ is from about 250 Pa to about 750 Pa.

In some embodiments, Pₚₒᵣₑₛ is from about 100 Pa to about 2,000 Pa. In other embodiments, Pₚₒᵣₑₛ is from about 200 Pa to about 1,800 Pa. In some embodiments, Pₚₒᵣₑₛ is from about 300 Pa to about 1,700 Pa. In some embodiments, Pₚₒᵣₑₛ is from about 400 Pa to about 1,600 Pa. In some embodiments, Pₚₒᵣₑₛ is from about 500 Pa to about 1,500 Pa. In other embodiments, Pₚₒᵣₑₛ is from about 600 Pa to about 1,400 Pa. In some embodiments, Pₚₒᵣₑₛ is from about 700 Pa to about 1,300 Pa. In some embodiments, Pₚₒᵣₑₛ is from about 750 Pa to about 1,250 Pa. In other embodiments, Pₚₒᵣₑₛ is from about 800 Pa to about 1,200 Pa. In some embodiments, Pₚₒᵣₑₛ is from about 850 Pa to about 1,150 Pa. In other embodiments, Pₚₒᵣₑₛ is from about 900 Pa to about 1,100 Pa. And, in some embodiments, Pₚₒᵣₑₛ is about 1,000 Pa.

In some embodiments, Pₚₒᵣₑₛ is from about 1,000 Pa to about 10,000 Pa. For example, Pₚₒᵣₑₛ may be from about 1,000 Pa to about 2,000 Pa. In some embodiments, Pₚₒᵣₑₛ is from about 2,000 Pa to about 3,000 Pa. In other embodiments, Pₚₒᵣₑₛ is from about 3,000 Pa to about 4,000 Pa. In some embodiments, Pₚₒᵣₑₛ is from about 4,000 Pa to about 5,000 Pa. In some embodiments, Pₚₒᵣₑₛ is from about 5,000 Pa to about 6,000 Pa. In other embodiments, Pₚₒᵣₑₛ is from about 6,000 Pa to about 7,000 Pa. In some embodiments, Pₚₒᵣₑₛ is from about 7,000 Pa to about 8,000 Pa. In some embodiments, Pₚₒᵣₑₛ is from about 8,000 Pa to about 9,000 Pa. In other embodiments, Pₚₒᵣₑₛ is from about 9,000 Pa to about 10,000 Pa. In some embodiments, Pₚₒᵣₑₛ is from about 1,000 Pa to about 5,000 Pa. In some embodiments, Pₚₒᵣₑₛ is from about 5,000 Pa to about 10,000 Pa. And, in some embodiments, Pₚₒᵣₑₛ is from about 2,500 Pa to about 7,500 Pa.

In some embodiments, Pₚₒᵣₑₛ is from about 10,000 Pa to about 101,324 Pa. For example, Pₚₒᵣₑₛ may be from about 10,000 Pa to about 20,000 Pa. In some embodiments, Pₚₒᵣₑₛ is from about 20,000 Pa to about 30,000 Pa. In other embodiments, Pₚₒᵣₑₛ is from about 30,000 Pa to about 40,000 Pa. In some embodiments, Pₚₒᵣₑₛ is from about 40,000 Pa to about 50,000 Pa. In some embodiments, Pₚₒᵣₑₛ is from about 50,000 Pa to about 60,000 Pa. In some embodiments, Pₚₒᵣₑₛ is from about 60,000 Pa to about 70,000 Pa. In some embodiments, Pₚₒᵣₑₛ is from about 70,000 Pa to about 80,000 Pa. In other embodiments, Pₚₒᵣₑₛ is from about 80,000 Pa to about 90,000 Pa. In some embodiments, Pₚₒᵣₑₛ is from about 90,000 Pa to about 100,000 Pa. In some embodiments, Pₚₒᵣₑₛ is from about 10,000 Pa to about 50,000 Pa. In some embodiments, Pₚₒᵣₑₛ is from about 50,000 Pa to about 100,000 Pa. And, in some embodiments, Pₚₒᵣₑₛ is from about 25,000 Pa to about 75,000 Pa.

In some embodiments, Pₚₒᵣₑₛ is from about 0.1 Pa to about 100 Pa. For example, Pₚₒᵣₑₛ may be from about 1 Pa to about 10 Pa. In some embodiments, Pₚₒᵣₑₛ is from about 10 Pa to about 20 Pa. In other embodiments, Pₚₒᵣₑₛ is from about 20 Pa to about 30 Pa. In some embodiments, Pₚₒᵣₑₛ is from about 30 Pa to about 40 Pa. In other embodiments, Pₚₒᵣₑₛ is from about 40 Pa to about 50 Pa. In some embodiments, Pₚₒᵣₑₛ is from about 50 Pa to about 60 Pa. In some embodiments, Pₚₒᵣₑₛ is from about 60 Pa to about 70 Pa. In some embodiments, Pₚₒᵣₑₛ is from about 70 Pa to about 80 Pa. In other embodiments, Pₚₒᵣₑₛ is from about 80 Pa to about 90 Pa. In some embodiments, Pₚₒᵣₑₛ is from about 90 Pa to about 100 Pa. In some embodiments, Pₚₒᵣₑₛ is from about 1 Pa to about 50 Pa. In other embodiments, Pₚₒᵣₑₛ is from about 50 Pa to about 100 Pa. In some embodiments, Pₚₒᵣₑₛ is from about 25 Pa to about 75 Pa. And, in some embodiments, Pₚₒᵣₑₛ is less than about 1 Pa.

In some embodiments, a pressure differential between Pₚₒᵣₑₛ and Pₑₙᵥ is from about 100 Pa to about 100,000 Pa. For example, the pressure differential between Pₚₒᵣₑₛ and Pₑₙᵥ may be from about 1,000 Pa to about 100,000 Pa. In some embodiments, the pressure differential between Pₚₒᵣₑₛ and Pₑₙᵥ is from about 10,000 Pa to about 100,000 Pa. And, in some embodiments, the pressure differential between Pₚₒᵣₑₛ and Pₑₙᵥ is greater than about 100,000 Pa (e.g., from about 100,000 to about 150,000 Pa).

In some embodiments, the pressure differential between Pₚₒᵣₑₛ and Pₑₙᵥ is from about 10,000 Pa to about 20,000 Pa. In other embodiments, the pressure differential between Pₚₒᵣₑₛ and Pₑₙᵥ is from about 20,000 Pa to about 30,000 Pa. In some embodiments, the pressure differential between Pₚₒᵣₑₛ and Pₑₙᵥ is from about 30,000 Pa to about 40,000 Pa. In other embodiments, the pressure differential between Pₚₒᵣₑₛ and Pₑₙᵥ is from about 40,000 Pa to about 50,000 Pa. In some embodiments, the pressure differential between Pₚₒᵣₑₛ and Pₑₙᵥ is from about 50,000 Pa to about 60,000 Pa. In other embodiments, the pressure differential between Pₚₒᵣₑₛ and Pₑₙᵥ is from about 60,000 Pa to about 70,000 Pa. In some embodiments, the pressure differential between Pₚₒᵣₑₛ and Pₑₙᵥ is from about 70,000 Pa to about 80,000 Pa. In some embodiments, the pressure differential between Pₚₒᵣₑₛ and Pₑₙᵥ is from about 80,000 Pa to about 90,000 Pa. In other embodiments, the pressure differential between Pₚₒᵣₑₛ and Pₑₙᵥ is from about 90,000 Pa to about 100,000 Pa. In some embodiments, the pressure differential between Pₚₒᵣₑₛ and Pₑₙᵥ is from about 10,000 Pa to about 50,000 Pa. In some embodiments, the pressure differential between Pₚₒᵣₑₛ and Pₑₙᵥ is from about 50,000 Pa to about 100,000 Pa. And, in some embodiments, the pressure differential between Pₚₒᵣₑₛ and Pₑₙᵥ is from about 25,000 Pa to about 75,000 Pa.

In some embodiments, the anode layer is disposed on an entire surface of the separator layer. In other embodiments, the anode layer is disposed on substantially all (e.g., at least 60%, at least 70%, at least 80%, at least 90%, or at least 95%) of a surface of the separator layer. And, in other embodiments, the anode layer is disposed only on a portion of a surface of the separator layer.

In some embodiments, the anode layer has an apparent porosity of from about 20% to about 80%. In other embodiments, the anode layer has an apparent porosity of from about 35% to about 75%. In some embodiments, the anode layer has an apparent porosity of from about 45% to about 65%. In some embodiments, the anode layer has an apparent porosity of from about 50% to about 60%. In some embodiments, the anode layer has an apparent porosity of from about 60% to about 80%. In some embodiments, the anode layer has an apparent porosity of from about 20% to about 95%. And, in some embodiments, the anode layer has an apparent porosity of from about 50% to about 90%.

In some embodiments, the SSE material of the anode layer and the SSE material of the separator layer are the same. In other embodiments, the SSE material of the anode layer and the SSE material of the separator layer are different. In some embodiments the SSE material comprises a lithium conductor, a sodium conductor, or a magnesium conductor. In some embodiments the SSE material comprises a lithium conductor. In other embodiments, the SSE material comprises a sodium conductor. And, in some embodiments, the SSE material comprises a magnesium conductor.

In some embodiments, the SSE material of the anode layer may comprise a garnet material. Non-limiting examples of garnet materials include lithium garnet materials, doped lithium garnet materials, lithium garnet composite materials, and combinations thereof. Non-limiting examples of lithium garnet materials include Li₃-phase lithium garnet SSE materials (e.g., Li₃M¹Te₂O₁₂, where M¹ is a lanthanide such as Y, Pr, Nd, Sm, Eu, Gd, Tb, Dy, Ho, Er, Tm, Yb, Lu, Zr, Ta, or a combination thereof and Li₃₊ₓNd₃Te₂₋ₓO₁₂, where x is 0.05 to 1.5; Li₅-phase lithium garnet SSE materials (e.g., Li₅La₃M²₂O₁₂, where M² is Nb, Zr, Ta, Sb, or a combination thereof, cation-substituted Li₅La₃M²₂O₁₂ such as, for example, Li₆M¹La₃M²₂O₁₂, where M¹ is Mg, Ca, Sr, Ba, or combinations thereof, and Li₇La₃M²₂O₁₂, where M² is Zr, Sn, or a combination thereof); Li₆-phase lithium garnet SSE materials (e.g., Li₆M¹La₂M²₂O₁₂, where M¹ is Mg, Ca, Sr, Ba, or a combination thereof and M² is Nb, Ta, or a combination thereof); cation-doped Li₆La₂BaTa₂O₁₂; cation-doped Li₆BaY₂M²₂O₁₂, where M² is Nb, Ta, or a combination thereof and the cation dopants are barium, yttrium, zinc, or combinations thereof, an Li₇-phase lithium garnet SSE material (e.g., cubic Li₇La₃Zr₂O₁₂ and Li₇Y₃Zr₂O₁₂); cation-doped Li₇La₃Zr₂O₁₂; Li_{52|x}La₃, Ta₂₋ₓO₂, where x is 0.1 to 1, Li_{6.8}(La_{2.95}Ca_{0.5})(Zr_{1.75}Nb_{0.25})O₁₂ (LLCZN), Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂), lithium garnet composite materials (e.g., lithium garnet-conductive carbon matrix or composites with other materials). Other examples of lithium-ion-conducting SSE materials include cubic garnet-type materials such as 3 mol % YSZ-doped Li_{7.6}La₃Zr_{1.94}Y_{0.06}O₁₂ and 8 mol % YSZ-doped Li_{7.16}La₃Zr_{1.94}Y_{0.06}O₁₂. Additional examples of suitable lithium garnet SSE materials include, but are not limited to, Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂. In some embodiments, the garnet material is, for example, Li₇₋ₓLa_{3-y}M¹_{y}Zr_{2-z}M²_{z}O₁₂, wherein x greater than 0 and less than 2, M¹ is chosen from Ba, Ca, Y, and combinations thereof, and M² is chosen from Nb, Ta, and combinations thereof. In some embodiments, the garnet material is Li_{6.75}La₃Zr_{1.75}Ta_{0.25}O₁₂ (LLZT), Li_{6.75}La_{2.75}Zr_{1.75}Ca_{0.25}Nb_{0.25}O₁₂ (LLZCN), Li₅La₃Nb₂O₁₂ (LLZNO), Li₇La₃Zr₂O₁₂ (LLZ), Li₅La₃Ta₂O₁₂, Li₆La₂SrNb₂O₁₂, Li₆La₂BaNb₂O₁₂, Li₆La₂SrTa₂O₁₂, Li₆La₇BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li_{6.75}BaLa₂Nb_{1.75}Zn_{0.25}O₁₂, Li_{6.75}BaLa₂Ta_{1.75}Zn_{0.25}O₁₂, or any combination thereof.

In some embodiments, the garnet material comprises a composition of Formula (I):

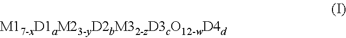

wherein
M1 is Li;
M2 is La;
M3 is Zr;
D1 is H, Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Tl, Pb, Ce, Eu, Te, Y, Sr, Ca, Ba, Gd, Ge, or any combination thereof; and
D4 is F, Cl, Br, I, S, Se, Te, N, P, or any combination thereof;
provided that
0≤w≤2;
−0.5<x≤3;
0≤y≤3;
0≤z≤2;
0≤a≤2;
0≤b≤3;
0≤c≤2; and
0≤d≤2;
   wherein at least one of a, b, c, and d is >0.

In some embodiments, the anode layer further comprises an anode material disposed in at least a portion of the pores of the anode layer. In some embodiments, the anode material comprises a lithium-containing material, a magnesium-containing material, a sodium-containing material, or any combination thereof. In other embodiments, the anode material comprises lithium metal, sodium metal, magnesium metal, or any combination thereof. In some embodiments, the anode material comprises lithium metal. In other embodiments, the anode material comprises sodium metal. And, in some embodiments, the anode material comprises magnesium metal.

In some embodiments, the pores of the anode layer are substantially free of an anode material (e.g., the pores comprise less than 1%, less than 0.5%, less than 0.25%, less than 0.1%, less than 0.01%, or less than 0.001% of the anode material by volume of the pores). In the context of this disclosure, when the pores of the anode layer are referred to as “substantially free of”, or “free of”, the anode material, it will be appreciated that the pores of the anode layer are substantially free, or free, of the anode material prior to operation of the battery cell, i.e., immediately after fabrication of the battery cell and prior to operation of the battery cell (e.g., charging/discharging of the battery cell). In some embodiments, the pores of the anode layer are substantially free of lithium metal, sodium metal, magnesium metal, or any combination thereof. In other embodiments, the pores of the anode layer are free of lithium metal, sodium metal, magnesium metal, or any combination thereof. In some embodiments, the pores of the anode layer are substantially free of lithium metal. And, in some embodiments, the pores of the anode layer are free of lithium metal.

As shown in FIG. 4A, in some embodiments, the anode layer 404 defines a first porous region 422 and a second porous region 424. The first porous region 422 is defined between a center 426 and the outer surface of the anode layer. The second porous region is defined between the first porous region and the outer surface of the anode layer.

With reference to FIGS. 3D and 3E, the anode layer may define a recess 328d, 328e. The recess 328d, 328e of the anode layer 304d, 304e may be defined on the first surface 314d, 314e the second surface 316d, and/or the outer surface 318d, 318e of the anode layer. For example, the recess may be a cut out around the periphery of the anode layer defined by the first surface, the second surface, and/or the outer surface, or a portion thereof, as shown in FIGS. 3D and 3E. In some embodiments, the first surface 314e, the second surface 316e, and the outer surface 318e of the anode layer define the recess 328e, as shown in FIG. 3E. In other embodiments, only the outer surface defines the recess. In some embodiments, only the second surface defines the recess. In some embodiments, only the first surface defines the recess. And, in some embodiments, only the outer surface defines the recess.

In some embodiments, the anode layer has a thickness of from about 1 μm to about 500 μm. In some embodiments, the anode layer has a thickness of from about 1 μm to about 200 μm. In other embodiments, the anode layer has a thickness of from about 1 μm to about 100 μm. In some embodiments, the anode layer has a thickness of from about 1 μm to about 50 μm. And, in some embodiments, the anode layer has a thickness of from about 1 μm to about 20 μm.

### C. Anode Current Collector

In some embodiments, as shown in FIG. 2A, the anode assembly 200 further comprises an anode current collector 230, an anode layer 204 (i.e., an anode layer having a first surface 214 facing the separator layer and a second surface 216 facing away from the separator layer 202), and a separator layer 202 (i.e., a separator layer having a front surface 206 facing the anode layer 204, a back surface 208 facing away from the anode layer 204, and an outer surface 210 extending from the front surface 206 to the back surface 208. The anode current collector 230 is coupled to the anode layer 204 (e.g., the second surface 216 of the anode layer). In some embodiments, the anode current collector 230 has an interior surface 232 facing the anode layer 204, an exterior surface 234 facing away from the anode layer 204, and an outer surface 236 extending from the interior surface 232 to the exterior surface 234.

In some embodiments, the anode current collector 230 is at least partially disposed on the second surface 216 of the anode layer. In some embodiments, the anode current collector 230 is disposed on the entire second surface 216 of the anode layer. In other embodiments, the anode current collector 230 is disposed on substantially all (e.g., at least 60%, at least 70%, at least 80%, at least 90%, or at least 95%) of the second surface 216 of the anode layer. And, in other embodiments, the anode current collector 230 is disposed only on a portion of the second surface of the anode layer 204.

In some embodiments, the anode current collector 230 comprises a metal foil 238, as shown in FIG. 2B. In such embodiments, the metal foil 238 is at least partially disposed on the second surface 216 of the anode layer 204. In some embodiments, the metal foil is disposed on the entire second surface 216 of anode layer 204. In other embodiments, the metal foil is disposed on substantially all (e.g., at least 60%, at least 70%, at least 80%, at least 90%, or at least 95%) of the second surface of the anode layer. And, in other embodiments, the metal foil is disposed only on a portion of the second surface 216 of the anode layer 204.

In some embodiments, the metal foil 238 has a tab 240 configured to connect with an external circuit, as shown in FIG. 2B. In the illustrated embodiment, the tab is integral with the metal foil. In other embodiments, the tab is coupled (e.g., welded) to the metal foil.

In some embodiments, the anode current collector comprises a tab configured to connect with an external circuit. In such embodiments, the anode current collector may comprise a tab alone and not the metal foil. For example, the anode current collector may comprise the tab and the tab may be coupled to the seal (e.g., disposed in the seal).

The anode current collector may be comprised of any suitable material. In some embodiments, the anode current collector (e.g., the metal foil and/or the tab) comprises copper, nickel, titanium, stainless steel, alloys thereof, or any combination thereof. In some embodiments, the anode current collector comprises copper. In other embodiments, the anode current collector comprises a copper alloy. In some embodiments, the anode current collector comprises nickel. In other embodiments, the anode current collector comprises a nickel alloy. In some embodiments, the anode current collector comprises titanium. In some embodiments, the anode current collector comprises a titanium alloy. In some embodiments, the anode current collector comprises stainless steel. And, in some embodiments, the anode current collector comprises a stainless steel alloy.

In some embodiments, the anode current collector comprises an electronically conductive film. For example, the electronically conductive film may comprise a polymer material and a conductive material. For example, the conductive material may be a metal material. In some embodiments, the conductive material comprises copper, nickel, titanium, stainless steel, alloys thereof, or any combination thereof. In some embodiments, the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

In some embodiments, electronically conductive tape couples the anode current collector to the anode layer. During operation of the battery cell (e.g., charging and/or discharging of the battery cell), the electronically conductive tape may electrically couple the anode current collector to the anode layer.

### D. Barrier

In some embodiments, the anode assembly further comprises a barrier. The barrier is disposed about the outer surface of the anode layer. The barrier defines an interior and an exterior. The anode layer is disposed in the interior of the barrier. The barrier is impervious to liquid and gas. And, the absolute pressure of the interior, Pᵢₙₜ, of the barrier is less than an absolute pressure of the exterior, Pₑₓₜ, of the barrier. When only a single barrier is present, it will be appreciated that Pₚₒᵣₑₛ is substantially the same as Pᵢₙₜ of the barrier.

In some embodiments, Pᵢₙₜ of the barrier is less than about 101,325 Pa. For example, Pᵢₙₜ of the barrier may be from about 1 Pa to about 101,324 Pa. In some embodiments, Pᵢₙₜ of the barrier is from about 100 Pa to about 1,000 Pa. In some embodiments, Pᵢₙₜ of the barrier is from about 100 Pa to about 200 Pa. In other embodiments, Pᵢₙₜ of the barrier is from about 200 Pa to about 300 Pa. In some embodiments, Pᵢₙₜ of the barrier is from about 300 Pa to about 400 Pa. In some embodiments, Pᵢₙₜ of the barrier is from about 400 Pa to about 500 Pa. In other embodiments, Pᵢₙₜ of the barrier is from about 500 Pa to about 600 Pa. In some embodiments, Pᵢₙₜ of the barrier is from about 600 Pa to about 700 Pa. In other embodiments, Pᵢₙₜ of the barrier is from about 700 Pa to about 800 Pa. In some embodiments, Pᵢₙₜ of the barrier is from about 800 Pa to about 900 Pa. In some embodiments, Pᵢₙₜ of the barrier is from about 900 Pa to about 1,000 Pa. In some embodiments, Pᵢₙₜ of the barrier is from about 100 Pa to about 500 Pa. In some embodiments, Pᵢₙₜ of the barrier is from about 500 Pa to about 1,000 Pa. And, in some embodiments, Pᵢₙₜ of the barrier is from about 250 Pa to about 750 Pa.

In some embodiments, Pᵢₙₜ of the barrier is from about 100 Pa to about 2,000 Pa. In other embodiments, Pᵢₙₜ of the barrier is from about 200 Pa to about 1,800 Pa. In some embodiments, Pᵢₙₜ of the barrier is from about 300 Pa to about 1,700 Pa. In some embodiments, Pᵢₙₜ of the barrier is from about 400 Pa to about 1,600 Pa. In some embodiments, Pᵢₙₜ of the barrier is from about 500 Pa to about 1,500 Pa. In other embodiments, Pᵢₙₜ of the barrier is from about 600 Pa to about 1,400 Pa. In some embodiments, Pᵢₙₜ of the barrier is from about 700 Pa to about 1,300 Pa. In some embodiments, Pᵢₙₜ of the barrier is from about 750 Pa to about 1,250 Pa. In other embodiments, Pᵢₙₜ of the barrier is from about 800 Pa to about 1,200 Pa. In some embodiments, Pᵢₙₜ of the barrier is from about 850 Pa to about 1,150 Pa. In other embodiments, Pᵢₙₜ of the barrier is from about 900 Pa to about 1,100 Pa. And, in some embodiments, Pᵢₙₜ of the barrier is about 1,000 Pa.

In some embodiments, Pᵢₙₜ of the barrier is from about 1,000 Pa to about 10,000 Pa. For example, Pᵢₙₜ of the barrier may be from about 1,000 Pa to about 2,000 Pa. In some embodiments, Pᵢₙₜ of the barrier is from about 2,000 Pa to about 3,000 Pa. In other embodiments, Pᵢₙₜ of the barrier is from about 3,000 Pa to about 4,000 Pa. In some embodiments, Pᵢₙₜ of the barrier is from about 4,000 Pa to about 5,000 Pa. In some embodiments, Pᵢₙₜ of the barrier is from about 5,000 Pa to about 6,000 Pa. In other embodiments, Pᵢₙₜ of the barrier is from about 6,000 Pa to about 7,000 Pa. In some embodiments, Pᵢₙₜ of the barrier is from about 7,000 Pa to about 8,000 Pa. In some embodiments, Pᵢₙₜ of the barrier is from about 8,000 Pa to about 9,000 Pa. In other embodiments, Pᵢₙₜ of the barrier is from about 9,000 Pa to about 10,000 Pa. In some embodiments, Pᵢₙₜ of the barrier is from about 1,000 Pa to about 5,000 Pa. In some embodiments, Pᵢₙₜ of the barrier is from about 5,000 Pa to about 10,000 Pa. And, in some embodiments, Pᵢₙₜ of the barrier is from about 2,500 Pa to about 7,500 Pa.

In some embodiments, Pᵢₙₜ of the barrier is from about 10,000 Pa to about 101,324 Pa. For example, Pᵢₙₜ of the barrier may be from about 10,000 Pa to about 20,000 Pa. In some embodiments, Pᵢₙₜ of the barrier is from about 20,000 Pa to about 30,000 Pa. In other embodiments, Pᵢₙₜ of the barrier is from about 30,000 Pa to about 40,000 Pa. In some embodiments, Pᵢₙₜ of the barrier is from about 40,000 Pa to about 50,000 Pa. In some embodiments, Pᵢₙₜ of the barrier is from about 50,000 Pa to about 60,000 Pa. In some embodiments, Pᵢₙₜ of the barrier is from about 60,000 Pa to about 70,000 Pa. In some embodiments, Pᵢₙₜ of the barrier is from about 70,000 Pa to about 80,000 Pa. In other embodiments, Pᵢₙₜ of the barrier is from about 80,000 Pa to about 90,000 Pa. In some embodiments, Pᵢₙₜ of the barrier is from about 90,000 Pa to about 100,000 Pa. In some embodiments, Pᵢₙₜ of the barrier is from about 10,000 Pa to about 50,000 Pa. In some embodiments, Pᵢₙₜ of the barrier is from about 50,000 Pa to about 100,000 Pa. And, in some embodiments, Pᵢₙₜ of the barrier is from about 25,000 Pa to about 75,000 Pa.

In some embodiments, Pᵢₙₜ of the barrier is from about 0.1 Pa to about 100 Pa. For example, Pᵢₙₜ of the barrier may be from about 1 Pa to about 10 Pa. In some embodiments, Pᵢₙₜ of the barrier is from about 10 Pa to about 20 Pa. In other embodiments, Pᵢₙₜ of the barrier is from about 20 Pa to about 30 Pa. In some embodiments, Pᵢₙₜ of the barrier is from about 30 Pa to about 40 Pa. In other embodiments, Pᵢₙₜ of the barrier is from about 40 Pa to about 50 Pa. In some embodiments, Pᵢₙₜ of the barrier is from about 50 Pa to about 60 Pa. In some embodiments, Pᵢₙₜ of the barrier is from about 60 Pa to about 70 Pa. In some embodiments, Pᵢₙₜ of the barrier is from about 70 Pa to about 80 Pa. In other embodiments, Pᵢₙₜ of the barrier is from about 80 Pa to about 90 Pa. In some embodiments, Pᵢₙₜ of the barrier is from about 90 Pa to about 100 Pa. In some embodiments, Pᵢₙₜ of the barrier is from about 1 Pa to about 50 Pa. In other embodiments, Pᵢₙₜ of the barrier is from about 50 Pa to about 100 Pa. In some embodiments, Pᵢₙₜ of the barrier is from about 25 Pa to about 75 Pa. And, in some embodiments, Pᵢₙₜ of the barrier is less than about 1 Pa.

In some embodiments, a pressure differential between Pᵢₙₜ and Pₑₓₜ of the barrier is from about 100 Pa to about 100,000 Pa. For example, the pressure differential between Pᵢₙₜ and Pₑₓₜ of the barrier may be from about 1,000 Pa to about 100,000 Pa. In some embodiments, the pressure differential between Pᵢₙₜ and Pₑₓₜ of the barrier is from about 10,000 Pa to about 100,000 Pa. And, in some embodiments, the pressure differential between Pᵢₙₜ and Pₑₓₜ of the barrier is greater than about 100,000 Pa (e.g., from about 100,000 to about 150,000 Pa).

In some embodiments, the pressure differential between Pᵢₙₜ and Pₑₓₜ of the barrier is from about 10,000 Pa to about 20,000 Pa. In other embodiments, the pressure differential between Pᵢₙₜ and Pₑₓₜ of the barrier is from about 20,000 Pa to about 30,000 Pa. In some embodiments, the pressure differential between Pᵢₙₜ and Pₑₓₜ of the barrier is from about 30,000 Pa to about 40,000 Pa. In other embodiments, the pressure differential between Pᵢₙₜ and Pₑₓₜ of the barrier is from about 40,000 Pa to about 50,000 Pa. In some embodiments, the pressure differential between Pᵢₙₜ and Pₑₓₜ of the barrier is from about 50,000 Pa to about 60,000 Pa. In other embodiments, the pressure differential between Pᵢₙₜ and Pₑₓₜ of the barrier is from about 60,000 Pa to about 70,000 Pa. In some embodiments, the pressure differential between Pᵢₙₜ and Pₑₓₜ of the barrier is from about 70,000 Pa to about 80,000 Pa. In some embodiments, the pressure differential between Pᵢₙₜ and Pₑₓₜ of the barrier is from about 80,000 Pa to about 90,000 Pa. In other embodiments, the pressure differential between Pᵢₙₜ and Pₑₓₜ of the barrier is from about 90,000 Pa to about 100,000 Pa. In some embodiments, the pressure differential between Pᵢₙₜ and Pₑₓₜ of the barrier is from about 10,000 Pa to about 50,000 Pa. In some embodiments, the pressure differential between Pᵢₙₜ and Pₑₓₜ of the barrier is from about 50,000 Pa to about 100,000 Pa. And, in some embodiments, the pressure differential between Pᵢₙₜ and Pₑₓₜ of the barrier is from about 25,000 Pa to about 75,000 Pa.

In some embodiments, the barrier is a seal as described herein. In other embodiments, the barrier is a housing as described herein. When the anode assembly comprises each of a seal and a housing, it will be appreciated that at least one of the seal and the housing is impervious to liquid and gas (i.e., the barrier is at least one of the seal and the housing). For example, in some embodiments, the seal is substantially impervious to liquid and pervious to gas, and the housing is impervious to liquid and gas (i.e., the barrier is the housing). In other embodiments, the seal is impervious to liquid and gas and the housing is substantially impervious to liquid and pervious to gas (i.e., the barrier is the seal).

In some embodiments, each of the seal and the housing is a barrier (i.e., each of the seal and the housing are impervious to liquid and gas). In such embodiments, it will be appreciated that Pₚₒᵣₑₛ is substantially the same as Pᵢₙₜ of the inner barrier (i.e., the barrier disposed within the other barrier). Moreover, in such embodiments, it will be appreciated that Pᵢₙₜ of the inner barrier is less than Pₑₓₜ of the outer barrier. Furthermore, in such embodiments, Pᵢₙₜ of the inner barrier may be less than, equal to, or greater than Pᵢₙₜ of the outer barrier.

Without wishing to be bound by theory, it is believed that the barrier ensures that Pᵢₙₜ, and therefore Pₚₒᵣₑₛ, remain less than Pₑₓₜ prior to operation of any battery cell comprising the anode layer. Moreover, as the anode layer is plated with an anode material during operation of the battery cell, thereby resulting in increased pressure within the anode layer, the lower initial absolute pressure within the barrier prevents failure of the barrier (e.g., rupturing) as a result of the increased pressure.

### 1. Seal

With reference to FIG. 2A, in some embodiments, the barrier of anode assembly 200 is seal 242. The seal is disposed about the outer surface 218 of the anode layer 204 and along with interior surface 232 and front surface 206 of separator layer 202 defines an interior space 244 and an exterior space 246. The seal comprises a sealant material as known to a person of ordinary skill in the art. The anode layer is disposed in the interior space 244.

When the barrier is the seal, the seal is generally impervious to liquid and gas. However, it will be appreciated that when the anode assembly includes a seal, and the barrier is other than the seal (e.g., a housing), the seal may be impervious to liquid and pervious to gas. In some embodiments, an absolute pressure of the interior, Pᵢₙₜ, of the interior space 244 is less than an absolute pressure of the exterior, Pₑₓₜ, of the seal, e.g., space 246. When the seal is present, and the seal is impervious to liquids and gases, it will be appreciated that Pₚₒᵣₑₛ is substantially the same as Pᵢₙₜ of the seal 242.

In some embodiments, Pᵢₙₜ of interior space 244 is less than about 101,325 Pa. For example, Pᵢₙₜ may be from about 1 Pa to about 101,324 Pa. In some embodiments, Pᵢₙₜ is from about 100 Pa to about 1,000 Pa. In some embodiments, Pᵢₙₜ is from about 100 Pa to about 200 Pa. In other embodiments, Pᵢₙₜ is from about 200 Pa to about 300 Pa. In some embodiments, Pᵢₙₜ is from about 300 Pa to about 400 Pa. In some embodiments, Pᵢₙₜ is from about 400 Pa to about 500 Pa. In other embodiments, Pᵢₙₜ is from about 500 Pa to about 600 Pa. In some embodiments, Pᵢₙₜ is from about 600 Pa to about 700 Pa. In other embodiments, Pᵢₙₜ is from about 700 Pa to about 800 Pa. In some embodiments, Pᵢₙₜ is from about 800 Pa to about 900 Pa. In some embodiments, Pᵢₙₜ is from about 900 Pa to about 1,000 Pa. In some embodiments, Pᵢₙₜ of the seal is from about 100 Pa to about 500 Pa. In some embodiments, Pᵢₙₜ of the seal is from about 500 Pa to about 1,000 Pa. And, in some embodiments, Pᵢₙₜ of the seal is from about 250 Pa to about 750 Pa.

In some embodiments, Pᵢₙₜ of the seal is from about 100 Pa to about 2,000 Pa. In other embodiments, Pᵢₙₜ of the seal is from about 200 Pa to about 1,800 Pa. In some embodiments, Pᵢₙₜ of the seal is from about 300 Pa to about 1,700 Pa. In some embodiments, Pᵢₙₜ of the seal is from about 400 Pa to about 1,600 Pa. In some embodiments, Pᵢₙₜ of the seal is from about 500 Pa to about 1,500 Pa. In other embodiments, Pᵢₙₜ of the seal is from about 600 Pa to about 1,400 Pa. In some embodiments, Pᵢₙₜ of the seal is from about 700 Pa to about 1,300 Pa. In some embodiments, Pᵢₙₜ of the seal is from about 750 Pa to about 1,250 Pa. In other embodiments, Pᵢₙₜ of the seal is from about 800 Pa to about 1,200 Pa. In some embodiments, Pᵢₙₜ of the seal is from about 850 Pa to about 1,150 Pa. In other embodiments, Pᵢₙₜ of the seal is from about 900 Pa to about 1,100 Pa. And, in some embodiments, Pᵢₙₜ of the seal is about 1,000 Pa.

In some embodiments, Pᵢₙₜ of the seal is from about 1,000 Pa to about 10,000 Pa. For example, Pᵢₙₜ of the seal may be from about 1,000 Pa to about 2,000 Pa. In some embodiments, Pᵢₙₜ of the seal is from about 2,000 Pa to about 3,000 Pa. In other embodiments, Pᵢₙₜ of the seal is from about 3,000 Pa to about 4,000 Pa. In some embodiments, Pᵢₙₜ of the seal is from about 4,000 Pa to about 5,000 Pa. In some embodiments, Pᵢₙₜ of the seal is from about 5,000 Pa to about 6,000 Pa. In other embodiments, Pᵢₙₜ of the seal is from about 6,000 Pa to about 7,000 Pa. In some embodiments, Pᵢₙₜ of the seal is from about 7,000 Pa to about 8,000 Pa. In some embodiments, Pᵢₙₜ of the seal is from about 8,000 Pa to about 9,000 Pa. In other embodiments, Pᵢₙₜ of the seal is from about 9,000 Pa to about 10,000 Pa. In some embodiments, Pᵢₙₜ of the seal is from about 1,000 Pa to about 5,000 Pa. In some embodiments, Pᵢₙₜ of the seal is from about 5,000 Pa to about 10,000 Pa. And, in some embodiments, Pᵢₙₜ of the seal is from about 2,500 Pa to about 7,500 Pa.

In some embodiments, Pᵢₙₜ of the seal is from about 10,000 Pa to about 101,324 Pa. For example, Pᵢₙₜ of the seal may be from about 10,000 Pa to about 20,000 Pa. In some embodiments, Pᵢₙₜ of the seal is from about 20,000 Pa to about 30,000 Pa. In other embodiments, Pᵢₙₜ of the seal is from about 30,000 Pa to about 40,000 Pa. In some embodiments, Pᵢₙₜ of the seal is from about 40,000 Pa to about 50,000 Pa. In some embodiments, Pᵢₙₜ of the seal is from about 50,000 Pa to about 60,000 Pa. In some embodiments, Pᵢₙₜ of the seal is from about 60,000 Pa to about 70,000 Pa. In some embodiments, Pᵢₙₜ of the seal is from about 70,000 Pa to about 80,000 Pa. In other embodiments, Pᵢₙₜ of the seal is from about 80,000 Pa to about 90,000 Pa. In some embodiments, Pᵢₙₜ of the seal is from about 90,000 Pa to about 100,000 Pa. In some embodiments, Pᵢₙₜ of the seal is from about 10,000 Pa to about 50,000 Pa. In some embodiments, Pᵢₙₜ of the seal is from about 50,000 Pa to about 100,000 Pa. And, in some embodiments, Pᵢₙₜ of the seal is from about 25,000 Pa to about 75,000 Pa.

In some embodiments, Pᵢₙₜ of the seal is from about 0.1 Pa to about 100 Pa. For example, Pᵢₙₜ of the seal may be from about 1 Pa to about 10 Pa. In some embodiments, Pᵢₙₜ of the seal is from about 10 Pa to about 20 Pa. In other embodiments, Pᵢₙₜ of the seal is from about 20 Pa to about 30 Pa. In some embodiments, Pᵢₙₜ of the seal is from about 30 Pa to about 40 Pa. In other embodiments, Pᵢₙₜ of the seal is from about 40 Pa to about 50 Pa. In some embodiments, Pᵢₙₜ of the seal is from about 50 Pa to about 60 Pa. In some embodiments, Pᵢₙₜ of the seal is from about 60 Pa to about 70 Pa. In some embodiments, Pᵢₙₜ of the seal is from about 70 Pa to about 80 Pa. In other embodiments, Pᵢₙₜ of the seal is from about 80 Pa to about 90 Pa. In some embodiments, Pᵢₙₜ of the seal is from about 90 Pa to about 100 Pa. In some embodiments, Pᵢₙₜ of the seal is from about 1 Pa to about 50 Pa. In other embodiments, Pᵢₙₜ of the seal is from about 50 Pa to about 100 Pa. In some embodiments, Pᵢₙₜ of the seal is from about 25 Pa to about 75 Pa. And, in some embodiments, Pᵢₙₜ of the seal is less than about 1 Pa.

In some embodiments, a pressure differential between Pᵢₙₜ and Pₑₓₜ of the seal is from about 100 Pa to about 100,000 Pa. For example, the pressure differential between Pᵢₙₜ and Pₑₓₜ of the seal may be from about 1,000 Pa to about 100,000 Pa. In some embodiments, the pressure differential between Pᵢₙₜ and Pₑₓₜ of the seal is from about 10,000 Pa to about 100,000 Pa. And, in some embodiments, the pressure differential between Pᵢₙₜ and Pₑₓₜ of the seal is greater than about 100,000 Pa (e.g., from about 100,000 to about 150,000 Pa).

In some embodiments, the pressure differential between Pᵢₙₜ and Pₑₓₜ of the seal is from about 10,000 Pa to about 20,000 Pa. In other embodiments, the pressure differential between Pᵢₙₜ and Pₑₓₜ of the seal is from about 20,000 Pa to about 30,000 Pa. In some embodiments, the pressure differential between Pᵢₙₜ and Pₑₓₜ of the seal is from about 30,000 Pa to about 40,000 Pa. In other embodiments, the pressure differential between Pᵢₙₜ and Pₑₓₜ of the seal is from about 40,000 Pa to about 50,000 Pa. In some embodiments, the pressure differential between Pᵢₙₜ and Pₑₓₜ of the seal is from about 50,000 Pa to about 60,000 Pa. In other embodiments, the pressure differential between Pᵢₙₜ and Pₑₓₜ of the seal is from about 60,000 Pa to about 70,000 Pa. In some embodiments, the pressure differential between Pᵢₙₜ and Pₑₓₜ of the seal is from about 70,000 Pa to about 80,000 Pa. In some embodiments, the pressure differential between Pᵢₙₜ and Pₑₓₜ of the seal is from about 80,000 Pa to about 90,000 Pa. In other embodiments, the pressure differential between Pᵢₙₜ and Pₑₓₜ of the seal is from about 90,000 Pa to about 100,000 Pa. In some embodiments, the pressure differential between Pᵢₙₜ and Pₑₓₜ of the seal is from about 10,000 Pa to about 50,000 Pa. In some embodiments, the pressure differential between Pᵢₙₜ and Pₑₓₜ of the seal is from about 50,000 Pa to about 100,000 Pa. And, in some embodiments, the pressure differential between Pᵢₙₜ and Pₑₓₜ of the seal is from about 25,000 Pa to about 75,000 Pa.

Referring to FIGS. 3A-3E, in some embodiments, anode assembly 300 comprises an anode current collector 330, an anode layer 304, a separator layer 302, and a seal 342. In some embodiments, the seal 242, 342 is at least partially disposed on the outer surface of the anode layer 304. In some embodiments, the seal 242, 342 is disposed on the entire outer surface 218, 318d, 318e of the anode layer 204, 304, 304b, 304c, 304d, 304e as shown in FIGS. 2A and 3A-3E. In other embodiments, the seal 242, 342 is disposed on substantially all (e.g., at least 60%, at least 70%, at least 80%, at least 90%, or at least 95%) of the outer surface 218, 318d, 318e of the anode layer 204, 304, 304b, 304c, 304d, 304e. And, in other embodiments, the seal 542 is disposed only on a portion of the outer surface 518 of the anode layer 504, as shown in FIG. 5A.

In some embodiments, the separator layer 302 is disposed in the interior of the seal. In other embodiments, the anode current collector is disposed in the interior of the seal. And, in some embodiments, the separator layer and the anode current collector are disposed in the interior of the seal.

In some embodiments, when the anode layer defines the first and second porous regions, the pores of the first porous region are substantially free of the sealant material (e.g., the pores comprise less than 1%, less than 0.5%, less than 0.25%, less than 0.1%, less than 0.01%, or less than 0.001% of the sealant material by volume of the pores). In other embodiments, the pores of the first porous region are free of the sealant material.

In some embodiments, at least a portion of the pores of the second porous region comprise the sealant material, as shown in FIG. 4A.

With reference to FIG. 3A-3E, when the anode layer 304b, 304c, 304d, 304e, defines a recess, e.g, 328d and 328e, the seal 342d, 342e may be disposed in recess 328d, 328e, as shown in FIGS. 3D and 3E, respectfully. When the separator layer 302b, 302c defines a recess 312b, 312c, seal 342b, 342c may be disposed in the recess 312b, 312c, as shown in FIGS. 3B and 3C. Without wishing to be bound by theory, it is believed that the recesses 328d, 328e of the anode layer 304d, 304e and/or separator layer 312b, 312c increase a surface area for the seal 342 to bond as compared to un-recessed bonding surfaces of an anode layer and/or separator layer.

In some embodiments, the seal 342, 642, 742 is at least partially disposed on the separator layer 302, 602, 702, as shown in FIGS. 3A, 6A, and 7A, respectively. In some embodiments, the seal 342, 642, 742 is at least partially disposed on the outer surface 314 of the separator layer 302, 602, 702. In some embodiments, the seal 342, 642, 742 is disposed on the entire outer surface of the separator layer 302, 602, 702, as shown in FIGS. 6A and 7A. In other embodiments, the seal 302, 602, 702 is disposed on substantially all (e.g., at least 60%, at least 70%, at least 80%, at least 90%, or at least 95%) of the outer surface of the separator layer 302, 602, 702. And, in some embodiments, the seal 342, 642, 742 is disposed only on a portion of the outer surface of the separator layer.

In some embodiments, the seal 342, 642, 742 is at least partially disposed on the back surface of the separator layer 302, 602, 702. In other embodiments, the seal 342, 642, 742 is disposed on substantially all (e.g., at least 60%, at least 70%, at least 80%, at least 90%, or at least 95%) of the back surface of the separator layer 302, 602, 702. And, in other embodiments, the seal 342, 642, 742 is disposed only on a portion of the back surface of the separator layer 302, 602, 702, as shown in FIGS. 3A, 6A, and 7A.

In some embodiments, the seal 342, 642, 742 is at least partially disposed on the front surface of the separator layer. In other embodiments, the seal 342, 642, 742 is disposed on substantially all (e.g., at least 60%, at least 70%, at least 80%, at least 90%, or at least 95%) of the front surface of the separator layer 302, 602, 702. And, in other embodiments, the seal 342e is disposed only on a portion of the front surface of the separator layer 302, 602, 702, as shown in FIG. 3E.

In some embodiments, the seal 642, 742 is disposed at least partially on the outer surface and the back surface of the separator layer 602, 702, as shown in FIGS. 6A and 7A. In the illustrated embodiments, the seal 642, 742 is disposed on the entire outer surface and only a portion of the back surface of the separator layer. In other embodiments, the seal 342e is disposed at least partially on the outer surface 318e, the front surface, and the back surface of the separator layer, as shown in FIG. 3E. As illustrated, the seal 342e is disposed on the entire outer surface 342e and only a portion of the front and back surfaces of the separator layer.

In other embodiments, e.g., as shown in FIGS. 2A and 2B, the separator layer is free of the seal. In other words, the seal is not disposed on any surface (e.g., the front surface, the back surface, and/or the outer surface) of the separator layer.

In some embodiments, the seal 242, 642, 742 is at least partially disposed on the anode current collector 230, 530, 630 as shown in FIGS. 2A, 5A, and 6A. In some embodiments, the seal 242, 642, 742 is at least partially disposed on the outer surface of the anode current collector 230, 530, 630. In some embodiments, the seal 542 is disposed on the entire outer surface of the anode current collector, as shown in FIG. 5A. In other embodiments, the seal is disposed on substantially all (e.g., at least 60%, at least 70%, at least 80%, at least 90%, or at least 95%) of the outer surface of the anode current collector. And, in some embodiments, the seal is disposed only on a portion of the outer surface of the anode current collector.

In some embodiments, the seal is at least partially disposed on the interior surface of the anode current collector. In other embodiments, the seal is disposed on substantially all (e.g., at least 60%, at least 70%, at least 80%, at least 90%, or at least 95%) of the interior surface of the anode current collector. And, in other embodiments, the seal 242, 742 is disposed only on a portion of the interior surface of the anode current collector, as shown in FIGS. 2A and 7A.

In some embodiments, e.g., as shown in FIGS. 8A and 8C, the seal 842, 842′ is at least partially disposed on the exterior surface 834 of the anode current collector 830. In some embodiments, the seal 842, 842′ is disposed on the entire exterior surface 834 of the anode current collector 830. In other embodiments, the seal 842, 842′ is disposed on substantially all (e.g., at least 60%, at least 70%, at least 80%, at least 90%, or at least 95%) of the exterior surface 834 of the anode current collector 830. And, in other embodiments, the seal 842, 842′ is disposed only on a portion of the outer surface of the anode current collector.

In some embodiments, the seal 842, 842′ is at least partially disposed on the exterior surface and the outer surface 834 of the anode current collector 830, as shown in FIGS. 8A and 8C. In the illustrated embodiments, the seal 842, 842′ is disposed on the entire exterior surface 834 and outer surface 836 of the anode current collector 830.

In other embodiments, e.g., as shown in FIG. 5A, the anode current collector 530 is free of the seal 542. In other words, the seal 542 is not disposed on any surface (e.g., the interior surface, the exterior surface, and/or the outer surface) of the anode current collector 530.

In some embodiments, the seal 642 is at least partially disposed on each of the outer surface of the anode layer 604, the outer surface of the separator layer 602, and the outer surface of the anode current collector 630, as shown in FIG. 6A. In other embodiments, the seal 842, 842′ is at least partially disposed on each of the outer surface of the anode layer, the outer surface of the separator layer, the outer surface of the anode current collector 830, and the exterior surface of the anode current collector 830, as shown in FIGS. 8A and 8C. And, in some embodiments, the seal 742 is at least partially disposed on each of the outer surface of the anode layer 704, the outer surface of the separator layer, and the interior surface of the anode current collector 730, as shown in FIG. 7A.

With reference to FIG. 4A, the seal 442 may be at least partially disposed on the outer surface of the anode layer and in the pores of the second porous region of the anode layer. In embodiments where the seal is disposed in the pores of the anode layer (e.g., a portion of the pores of the second porous region), the seal may also restrict flow of anode active material (e.g., lithium metal) outside of the anode layer.

The sealant material may be any material suitable for restricting flow of a liquids and/or gases into, or out of, the anode layer. In some embodiments, the sealant material comprises a non-conductive (e.g., non-ionically conductive and non-electronically conductive) polymer, a non-conductive (e.g., non-ionically conductive and non-electronically conductive) glass, or any combination thereof. In other embodiments, the sealant material comprises a non-conductive polymer. In some embodiments, the sealant material comprises a non-conductive glass. For example, the sealant material may be a glass having a low coefficient of thermal expansion (CTE). As another example, the sealant material may be a glass ceramic.

In some embodiments, the sealant material comprises polypropylene, polyethylene, polyimide, polyvinyl chloride (PVC), ethylene-vinyl acetate, polyamide, polypropylene, polyurethane, copolymers thereof, or any combination thereof. For example, the sealant material may comprise polypropylene. In some embodiments, the sealant material comprises polyethylene. In other embodiments, the sealant material comprises polyimide. In some embodiments, the sealant material comprises PVC. In some embodiments, the sealant material comprises ethylene-vinyl acetate. In other embodiments, the sealant material comprises polyamide. In some embodiments, the sealant material comprises polypropylene. And, in some embodiments, the sealant material comprises polyurethane.

In some embodiments, the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. In some embodiments, the sealant material comprises polypropylene. In some embodiments, the sealant material comprises polyethylene. In other embodiments, the sealant material comprises polymethylpentene. In some embodiments, the sealant material comprises polybutene-1. In some embodiments, the sealant material comprises ethylene-octene copolymers. In some embodiments, the sealant material comprises propylene-butane copolymers. In some embodiments, the sealant material comprises polyisobutylene. In some embodiments, the sealant material comprises poly(α-olefin). In some embodiments, the sealant material comprises ethylene propylene rubber. In other embodiments, the sealant material comprises ethylene propylene diene monomer rubber. In some embodiments, the sealant material comprises ethylene-vinyl acetate. In some embodiments, the sealant material comprises ethylene-acrylate copolymers. In other embodiments, the sealant material comprises polyamides. In some embodiments, the sealant material comprises polyesters. In some embodiments, the sealant material comprises polyurethanes. In some embodiments, the sealant material comprises styrene block copolymers. In some embodiments, the sealant material comprises polycaprolactone. In other embodiments, the sealant material comprises polyimide. In some embodiments, the sealant material comprises polyvinyl chloride. In some embodiments, the sealant material comprises polycarbonates. In some embodiments, the sealant material comprises polyacrylates. In some embodiments, the sealant material comprises polymethacrylates. In some embodiments, the sealant material comprises fluoropolymers. In some embodiments, the sealant material comprises epoxy resins. In other embodiments, the sealant material comprises epoxy polymers. And, in some embodiments, the sealant material comprises silicone rubber.

In some embodiments, the seal may comprise a conductive material. For example, the conductive material may be a metal material. In some embodiments, the conductive material comprises copper, aluminum nickel, titanium, stainless steel, alloys thereof, or any combination thereof.

In some embodiments, at least a portion of the seal has a thickness of from about 1 μm to about 50 μm. In some embodiments, at least a portion of the seal has a thickness of from about 1 μm to about 20 μm. In other embodiments, at least a portion of the seal has a thickness of from about 1 μm to about 10 μm. And, in some embodiments, at least a portion of the seal has a thickness of from about 1 μm to about 5 μm.

It will be appreciated that anode assembly thicknesses would include a dense layer (e.g. separator) having a thickness of 0 to 50 microns, a porous layer (e.g., an anode layer) having a thickness of 0 to 100 microns, and a seal or housing component having a thickness of 0 to 50 microns.

It will be appreciated that, when the seal is disposed on the outer surface of the anode layer, the seal, the separator layer, and/or the anode current collector may cooperate with the separator layer and/or the anode current collector to prevent flow of liquids and gases into, or out of, the anode layer.

### 2 Housing

With reference to FIGS. 5A and 5B, in some embodiments, the barrier is a housing 548, 548′. The housing has a plurality of interior walls 550, 550′, which with housing 548, 548′ define an interior 552, 552′ and an exterior 553, 533′. The separator layer 502, 502′, the anode layer 504, 504′, the anode current collector 530, 530′, and/or the seal 542 may be disposed in the interior of the housing 548, 548′.

When the barrier is the housing, the housing is impervious to liquid and gas. However, it will be appreciated that when the anode assembly includes a housing, and the barrier is other than the housing (e.g., a seal), the housing may be substantially impervious to liquid and pervious to gas. In some embodiments, an absolute pressure of the interior, Pᵢₙₜ, of the housing is less than an absolute pressure the exterior, Pₑₓₜ, of the housing. When the housing is present, the barrier is the housing (i.e., the housing is impervious to liquid and gas), and the anode assembly is free of a seal, it will be appreciated that Pₚₒᵣₑₛ is substantially the same as Pᵢₙₜ of the housing. In other embodiments, when the anode assembly comprises a seal substantially impervious to liquid and pervious to gas, and the barrier is the housing (i.e., the housing is impervious to liquid and gas), it will be appreciated that Pₚₒᵣₑₛ and Pᵢₙₜ of the seal are substantially the same as Pᵢₙₜ of the housing.

With reference to FIG. 5A, a seal 542 is disposed within the interior 552 of the housing 548. When the housing is impervious to liquid and gas, the seal 542 may be substantially impervious to liquid and previous to gas. In such embodiments, Pₚₒᵣₑₛ is substantially the same as Pᵢₙₜ of the housing.

In other embodiments, the seal may be impervious to liquid and impervious to gas, and Pₚₒᵣₑₛ is substantially the same as an interior formed by the plurality of walls of the housing and the seal. In such embodiments, the housing and the seal cooperate to form a barrier about the anode layer.

With reference to FIG. 5B, when the housing 548′ is present a seal may be absent. In such embodiments, the housing 548′ is impervious to liquid and gas, and Pₚₒᵣₑₛ is substantially the same as Pᵢₙₜ of the housing.

In some embodiments, Pᵢₙₜ of the housing is less than about 101,325 Pa. For example, Pᵢₙₜ of the housing may be from about 1 Pa to about 101,324 Pa. In some embodiments, Pᵢₙₜ of the housing is from about 100 Pa to about 1,000 Pa. In some embodiments, Pᵢₙₜ of the housing is from about 100 Pa to about 200 Pa. In other embodiments, Pᵢₙₜ of the housing is from about 200 Pa to about 300 Pa. In some embodiments, Pᵢₙₜ of the housing is from about 300 Pa to about 400 Pa. In some embodiments, Pᵢₙₜ of the housing is from about 400 Pa to about 500 Pa. In other embodiments, Pᵢₙₜ of the housing is from about 500 Pa to about 600 Pa. In some embodiments, Pᵢₙₜ of the housing is from about 600 Pa to about 700 Pa. In other embodiments, Pᵢₙₜ of the housing is from about 700 Pa to about 800 Pa. In some embodiments, Pᵢₙₜ of the housing is from about 800 Pa to about 900 Pa. In some embodiments, Pᵢₙₜ of the housing is from about 900 Pa to about 1,000 Pa. In some embodiments, Pᵢₙₜ of the housing is from about 100 Pa to about 500 Pa. In some embodiments, Pᵢₙₜ of the housing is from about 500 Pa to about 1,000 Pa. And, in some embodiments, Pᵢₙₜ of the housing is from about 250 Pa to about 750 Pa.

In some embodiments, Pᵢₙₜ of the housing is from about 100 Pa to about 2,000 Pa. In other embodiments, Pᵢₙₜ of the housing is from about 200 Pa to about 1,800 Pa. In some embodiments, Pᵢₙₜ of the housing is from about 300 Pa to about 1,700 Pa. In some embodiments, Pᵢₙₜ of the housing is from about 400 Pa to about 1,600 Pa. In some embodiments, Pᵢₙₜ of the housing is from about 500 Pa to about 1,500 Pa. In other embodiments, Pᵢₙₜ of the housing is from about 600 Pa to about 1,400 Pa. In some embodiments, Pᵢₙₜ of the housing is from about 700 Pa to about 1,300 Pa. In some embodiments, Pᵢₙₜ of the housing is from about 750 Pa to about 1,250 Pa. In other embodiments, Pᵢₙₜ of the housing is from about 800 Pa to about 1,200 Pa. In some embodiments, Pᵢₙₜ of the housing is from about 850 Pa to about 1,150 Pa. In other embodiments, Pᵢₙₜ of the housing is from about 900 Pa to about 1,100 Pa. And, in some embodiments, Pᵢₙₜ of the housing is about 1,000 Pa.

In some embodiments, Pᵢₙₜ of the housing is from about 1,000 Pa to about 10,000 Pa. For example, Pᵢₙₜ of the housing may be from about 1,000 Pa to about 2,000 Pa. In some embodiments, Pᵢₙₜ of the housing is from about 2,000 Pa to about 3,000 Pa. In other embodiments, Pᵢₙₜ of the housing is from about 3,000 Pa to about 4,000 Pa. In some embodiments, Pᵢₙₜ of the housing is from about 4,000 Pa to about 5,000 Pa. In some embodiments, Pᵢₙₜ of the housing is from about 5,000 Pa to about 6,000 Pa. In other embodiments, Pᵢₙₜ of the housing is from about 6,000 Pa to about 7,000 Pa. In some embodiments, Pᵢₙₜ of the housing is from about 7,000 Pa to about 8,000 Pa. In some embodiments, Pᵢₙₜ of the housing is from about 8,000 Pa to about 9,000 Pa. In other embodiments, Pᵢₙₜ of the housing is from about 9,000 Pa to about 10,000 Pa. In some embodiments, Pᵢₙₜ of the housing is from about 1,000 Pa to about 5,000 Pa. In some embodiments, Pᵢₙₜ of the housing is from about 5,000 Pa to about 10,000 Pa. And, in some embodiments, Pᵢₙₜ of the housing is from about 2,500 Pa to about 7,500 Pa.

In some embodiments, Pᵢₙₜ of the housing is from about 10,000 Pa to about 101,324 Pa. For example, Pᵢₙₜ of the housing may be from about 10,000 Pa to about 20,000 Pa. In some embodiments, Pᵢₙₜ of the housing is from about 20,000 Pa to about 30,000 Pa. In other embodiments, Pᵢₙₜ of the housing is from about 30,000 Pa to about 40,000 Pa. In some embodiments, Pᵢₙₜ of the housing is from about 40,000 Pa to about 50,000 Pa. In some embodiments, Pᵢₙₜ of the housing is from about 50,000 Pa to about 60,000 Pa. In some embodiments, Pᵢₙₜ of the housing is from about 60,000 Pa to about 70,000 Pa. In some embodiments, Pᵢₙₜ of the housing is from about 70,000 Pa to about 80,000 Pa. In other embodiments, Pᵢₙₜ of the housing is from about 80,000 Pa to about 90,000 Pa. In some embodiments, Pᵢₙₜ of the housing is from about 90,000 Pa to about 100,000 Pa. In some embodiments, Pᵢₙₜ of the housing is from about 10,000 Pa to about 50,000 Pa. In some embodiments, Pᵢₙₜ of the housing is from about 50,000 Pa to about 100,000 Pa. And, in some embodiments, Pᵢₙₜ of the housing is from about 25,000 Pa to about 75,000 Pa.

In some embodiments, Pᵢₙₜ of the housing is from about 0.1 Pa to about 100 Pa. For example, Pᵢₙₜ of the housing may be from about 1 Pa to about 10 Pa. In some embodiments, Pᵢₙₜ of the housing is from about 10 Pa to about 20 Pa. In other embodiments, Pᵢₙₜ of the housing is from about 20 Pa to about 30 Pa. In some embodiments, Pᵢₙₜ of the housing is from about 30 Pa to about 40 Pa. In other embodiments, Pᵢₙₜ of the housing is from about 40 Pa to about 50 Pa. In some embodiments, Pᵢₙₜ of the housing is from about 50 Pa to about 60 Pa. In some embodiments, Pᵢₙₜ of the housing is from about 60 Pa to about 70 Pa. In some embodiments, Pᵢₙₜ of the housing is from about 70 Pa to about 80 Pa. In other embodiments, Pᵢₙₜ of the housing is from about 80 Pa to about 90 Pa. In some embodiments, Pᵢₙₜ of the housing is from about 90 Pa to about 100 Pa. In some embodiments, Pᵢₙₜ of the housing is from about 1 Pa to about 50 Pa. In other embodiments, Pᵢₙₜ of the housing is from about 50 Pa to about 100 Pa. In some embodiments, Pᵢₙₜ of the housing is from about 25 Pa to about 75 Pa. And, in some embodiments, Pᵢₙₜ of the housing is less than about 1 Pa.

In some embodiments, a pressure differential between Pᵢₙₜ and Pₑₓₜ of the housing is from about 100 Pa to about 100,000 Pa. For example, the pressure differential between Pᵢₙₜ and Pₑₓₜ of the housing may be from about 1,000 Pa to about 100,000 Pa. In some embodiments, the pressure differential between Pᵢₙₜ and Pₑₓₜ of the housing is from about 10,000 Pa to about 100,000 Pa. And, in some embodiments, the pressure differential between Pᵢₙₜ and Pₑₓₜ of the housing is greater than about 100,000 Pa (e.g., from about 100,000 to about 150,000 Pa).

In some embodiments, the pressure differential between Pᵢₙₜ and Pₑₓₜ of the housing is from about 10,000 Pa to about 20,000 Pa. In other embodiments, the pressure differential between Pᵢₙₜ and Pₑₓₜ of the housing is from about 20,000 Pa to about 30,000 Pa. In some embodiments, the pressure differential between Pᵢₙₜ and Pₑₓₜ of the housing is from about 30,000 Pa to about 40,000 Pa. In other embodiments, the pressure differential between Pᵢₙₜ and Pₑₓₜ of the housing is from about 40,000 Pa to about 50,000 Pa. In some embodiments, the pressure differential between Pᵢₙₜ and Pₑₓₜ of the housing is from about 50,000 Pa to about 60,000 Pa. In other embodiments, the pressure differential between Pᵢₙₜ and Pₑₓₜ of the housing is from about 60,000 Pa to about 70,000 Pa. In some embodiments, the pressure differential between Pᵢₙₜ and Pₑₓₜ of the housing is from about 70,000 Pa to about 80,000 Pa. In some embodiments, the pressure differential between Pᵢₙₜ and Pₑₓₜ of the housing is from about 80,000 Pa to about 90,000 Pa. In other embodiments, the pressure differential between Pᵢₙₜ and Pₑₓₜ of the housing is from about 90,000 Pa to about 100,000 Pa. In some embodiments, the pressure differential between Pᵢₙₜ and Pₑₓₜ of the housing is from about 10,000 Pa to about 50,000 Pa. In some embodiments, the pressure differential between Pᵢₙₜ and Pₑₓₜ of the housing is from about 50,000 Pa to about 100,000 Pa. And, in some embodiments, the pressure differential between Pᵢₙₜ and Pₑₓₜ of the housing is from about 25,000 Pa to about 75,000 Pa.

The housing may be comprised of any suitable material. For example, the housing material may comprise any sealant material described herein. In some embodiments, the housing comprises a non-conductive (e.g., non-ionically conductive and non-electronically conductive) polymer, a non-conductive (e.g., non-ionically conductive and non-electronically conductive) glass, or any combination thereof. In other embodiments, the housing comprises a non-conductive polymer. In some embodiments, the housing comprises a non-conductive glass. For example, the housing may be a glass having a low coefficient of thermal expansion (CTE). As another example, the housing may be a glass ceramic.

In some embodiments, the housing comprises polypropylene, polyethylene, polyimide, polyvinyl chloride (PVC), ethylene-vinyl acetate, polyamide, polypropylene, polyurethane, copolymers thereof, or any combination thereof. For example, the housing may comprise polypropylene. In some embodiments, the housing comprises polyethylene. In other embodiments, the housing comprises polyimide. In some embodiments, the housing comprises PVC. In some embodiments, the housing comprises ethylene-vinyl acetate. In other embodiments, the housing comprises polyamide. In some embodiments, the housing comprises polypropylene. And, in some embodiments, the housing comprises polyurethane.

In some embodiments, the housing comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. In some embodiments, the housing comprises polypropylene. In some embodiments, the housing comprises polyethylene. In other embodiments, the housing comprises polymethylpentene. In some embodiments, the housing comprises polybutene-1. In some embodiments, the housing comprises ethylene-octene copolymers. In some embodiments, the housing comprises propylene-butane copolymers. In some embodiments, the housing comprises polyisobutylene. In some embodiments, the housing comprises poly(α-olefin). In some embodiments, the housing comprises ethylene propylene rubber. In other embodiments, the housing comprises ethylene propylene diene monomer rubber. In some embodiments, the housing comprises ethylene-vinyl acetate. In some embodiments, the housing comprises ethylene-acrylate copolymers. In other embodiments, the housing comprises polyamides. In some embodiments, the housing comprises polyesters. In some embodiments, the housing comprises polyurethanes. In some embodiments, the housing comprises styrene block copolymers. In some embodiments, the housing comprises polycaprolactone. In other embodiments, the housing comprises polyimide. In some embodiments, the housing comprises polyvinyl chloride. In some embodiments, the housing comprises polycarbonates. In some embodiments, the housing comprises polyacrylates. In some embodiments, the housing comprises polymethacrylates. In some embodiments, the housing comprises fluoropolymers. In some embodiments, the housing comprises epoxy resins. In other embodiments, the housing comprises epoxy polymers. And, in some embodiments, the housing comprises silicone rubber.

In some embodiments, the housing may comprise a conductive material. For example, the conductive material may be a metal material. In some embodiments, the conductive material comprises copper, nickel, aluminum, titanium, stainless steel, alloys thereof, or any combination thereof.

In some embodiments, the anode assembly is free of a component applying a substantial mechanical force on one or more of the anode layer, the separator layer, and the anode current collector.

In another aspect, the present inventions provides an anode assembly for a battery cell. The anode assembly comprises a separator, an anode layer, and a barrier. The anode layer is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The barrier is disposed about the outer surface of the anode layer and defines an interior and exterior. The barrier is impervious to liquid and gas. The anode layer is disposed in the interior of the barrier. And, an absolute pressure of the interior, Pᵢₙₜ, of the barrier is less than an absolute pressure of the exterior, Pₑₓₜ, of the barrier.

In some embodiments, the anode assembly is free of a component applying a substantial mechanical force on one or more of the anode layer, the separator layer, and the anode current collector.

In another aspect, the present inventions provides an anode assembly for a battery cell. The anode assembly comprises a separator, an anode layer, and a seal. The anode layer is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The seal is disposed about the outer surface of the anode layer and defines an interior and exterior. The seal comprises a sealant material. The seal is impervious to liquid and gas. The anode layer is disposed in the interior of the seal. And, an absolute pressure of the interior, Pᵢₙₜ, of the seal is less than an absolute pressure of the exterior, Pₑₓₜ, of the seal.

In a further aspect, the present inventions provides an anode assembly for a battery cell. The anode assembly comprises a housing, a separator, and an anode layer. The housing comprises a plurality of interior walls defining an interior and an exterior. The separator layer is disposed in the interior of the housing. The anode layer is disposed in the interior of the housing and is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The housing is impervious to liquid and gas. And, an absolute pressure of the interior, Pᵢₙₜ, of the housing is less than an absolute pressure of the exterior, Pₑₓₜ, of the housing.

In some embodiments, the anode assembly is free of a component applying a substantial mechanical force on one or more of the anode layer, the separator layer, and the anode current collector.

In another aspect, the present invention provides an anode assembly for a battery cell. The anode assembly comprises a separator layer, an anode layer, and an anode current collector. The anode layer is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The anode current collector is coupled to the second surface of the anode layer. And, an absolute pressure within the pores, Pₚₒᵣₑₛ, is less than an absolute pressure of an environment outside of the anode layer, Pₑₙᵥ.

In some embodiments, the anode assembly is free of a component applying a substantial mechanical force on one or more of the anode layer, the separator layer, and the anode current collector.

In one aspect, the present inventions provides an anode assembly for a battery cell. The anode assembly comprises a separator, an anode layer, an anode current collector, and a barrier. The anode layer is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The anode current collector is coupled to the second surface of the anode layer. The barrier is disposed about the outer surface of the anode layer and defines an interior and exterior. The barrier is impervious to liquid and gas. The anode layer is disposed in the interior of the barrier. And, an absolute pressure of the interior, Pᵢₙₜ, of the barrier is less than an absolute pressure of the exterior, Pₑₓₜ, of the barrier.

In yet another aspect, the present inventions provides an anode assembly for a battery cell. The anode assembly comprises a separator, an anode layer, an anode current collector, and a seal. The anode layer is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The anode current collector is coupled to the second surface of the anode layer. The seal is disposed about the outer surface of the anode layer and defines an interior and exterior. The seal comprises a sealant material. The seal is impervious to liquid and gas. The anode layer is disposed in the interior of the seal. And, an absolute pressure of the interior, Pᵢₙₜ, of the seal is less than an absolute pressure of the exterior, Pₑₓₜ, of the seal.

In some embodiments, the anode assembly is free of a component applying a substantial mechanical force on one or more of the anode layer, the separator layer, and the anode current collector.

In a further aspect, the present inventions provides an anode assembly for a battery cell. The anode assembly comprises a housing, a separator, an anode layer, and an anode current collector. The housing comprises a plurality of interior walls defining an interior and an exterior. The separator layer is disposed in the interior of the housing. The anode layer is disposed in the interior of the housing and at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The anode current collector is disposed in the interior of the housing and is coupled to the second surface of the anode layer. The housing is impervious to liquid and gas. And, an absolute pressure of the interior, Pᵢₙₜ, of the housing is less than an absolute pressure of the exterior, Pₑₓₜ, of the housing.

In some embodiments, the anode assembly is free of a component applying a substantial mechanical force on one or more of the anode layer, the separator layer, and the anode current collector.

In another aspect, the present inventions provides an anode assembly for a battery cell. The anode assembly comprises a housing, a separator, an anode layer, and a seal. The housing comprises a plurality of interior walls defining an interior and an exterior. The separator layer is disposed in the interior of the housing. The anode layer is disposed in the interior of the housing and at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The seal is disposed in the interior of the housing and is disposed about the outer surface of the anode layer. The seal defines an interior and exterior. The seal comprises a sealant material. The seal is impervious to liquid and gas. The anode layer is disposed in the interior of the seal. And, an absolute pressure of the interior, Pᵢₙₜ, of the seal is less than an absolute pressure of the exterior, Pₑₓₜ, of the seal.

In some embodiments, the anode assembly is free of a component applying a substantial mechanical force on one or more of the anode layer, the separator layer, and the anode current collector.

In a further aspect, the present inventions provides an anode assembly for a battery cell. The anode assembly comprises a housing, a separator, an anode layer, and a seal. The housing comprises a plurality of interior walls defining an interior. The separator layer is disposed in the interior of the housing. The anode layer is disposed in the interior of the housing and at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The seal is disposed in the interior of the housing and is disposed about the outer surface of the anode layer. The seal defines an interior and exterior. The seal comprises a sealant material. The seal is substantially impervious to liquid and pervious to gas. The anode layer is disposed in the interior of the seal. The housing is impervious to liquid and gas. And, an absolute pressure of the interior, Pᵢₙₜ, of the housing is less than an absolute pressure of the exterior, Pₑₓₜ, of the housing.

In some embodiments, the anode assembly is free of a component applying a substantial mechanical force on one or more of the anode layer, the separator layer, and the anode current collector.

### III. BATTERY CELL

Another aspect of the present invention provides a battery cell. With reference to FIG. 8A, the battery cell 854 comprises a separator layer 802, an anode layer 804, an anode current collector 830, a cathode layer 856, a cathode current collector 858, and a barrier (e.g., seal 842).

Example embodiments of a battery cell 854, 854′, 954, 954′, 1054, 1054′ according to the present invention are provided in FIGS. 8A-8D, 9A-9D, and 10A-10D.

In some embodiments, as illustrated in FIGS. 8A-8D, the battery cell 854 comprises an anode assembly including an anode layer 804, a separator layer 802 disposed on a first surface of the anode layer, and an anode current collector 830 having an interior surface 832, an exterior surface 834, and an outer surface 836 extending from the interior surface 832 to the exterior surface 834. The battery cell further comprises a cathode layer 856 disposed on the back surface of the separator layer 802 and a cathode current collector 858. In these embodiments, seal 842, 842′ is disposed about the outer surface of the anode layer 804, the outer surface of the separator layer 802, the outer surface 878 of the cathode layer, and the exterior surface of the anode current collector 830 (leaving exposed a tab 840 configured to connect with an external circuit) and defines an interior and exterior. The seal comprises a sealant material. The seal is impervious to liquid and gas. The anode layer is disposed in the interior of the seal. And, an absolute pressure of the interior, Pᵢₙₜ, of the seal is less than an absolute pressure of the exterior, Pₑₓₜ, of the seal. In some of these embodiments, as shown in FIG. 8D, cathode current collector further comprises a tab 874 configured to connect with an external circuit. In some embodiments, e.g., FIG. 8A, seal 842 is also disposed about an interior surface of the cathode current collector 858 leaving the exterior surface (the surfacing facing away from the interior surface) exposed. In alternative embodiments, e.g., FIG. 8D, seal 842′ is disposed about the interior surface of the cathode current collector 858′ and at least a portion of an outer surface of the cathode current collector.

The separator layer 902 may be any separator layer described herein. For example, the separator layer may have a front surface 906, a back surface 908 spaced from the front surface, and an outer surface 902 extending from the front surface 906 to the back surface 908.

The anode layer 904 may be any anode layer described herein. For example, the anode layer 904 may be at least partially disposed on the front surface 906 of the separator layer 902. The anode layer 904 may have a first surface facing the separator layer 902, a second surface facing away from the separator layer 902, and an outer surface 902 extending from the first surface to the second surface. And, the anode layer may comprise a SSE having pores.

The anode current collector may be any anode current collector described herein. For example, the anode current collector may be coupled to the second surface of the anode layer.

### A. Cathode Layer

With reference to FIG. 9A, the cathode layer is at least partially disposed on the back surface 908 of the separator layer 902. The cathode layer has a first surface 960 facing the separator layer, a second surface 962 facing away from the separator layer, and an outer surface 964 extending from the first surface to the second surface.

In some embodiments, the cathode layer is disposed on the entire back surface of the separator layer. In other embodiments, the cathode layer is disposed on substantially all (e.g., at least 60%, at least 70%, at least 80%, at least 90%, or at least 95%) of the back surface of the separator layer. And, in some embodiments, the cathode layer is disposed only on a portion of the back surface of the separator layer.

The cathode layer may be comprised of any suitable material. In some embodiments, the cathode layer comprises a lithium ion-conducting material. For example, the lithium ion-conducting material may be lithium nickel manganese cobalt oxides (NMC, LiNiₓMn_{y}Co_{z}O₂, wherein x+y+z=1), such as LiCoO₂, LiNi_{1/3}Co_{1/3}Mn_{1/3}O₂, LiNi_{0.5}Co_{0.2}Mn_{0.3}O₂; lithium manganese oxides (LMOs), such as LiMn₂O₄, LiNi_{0.5}Mn_{1.5}O₄; lithium iron phosphates (LFPs) such as LiFePO₄, LiMnPO₄, and LiCoPO₄, and Li₂MMn₃O₈, wherein M is selected from Fe, Co, or any combination thereof. In some embodiments, the ion-conducting cathode material is a high energy ion-conducting cathode material such as Li₂MMn₃O₈, wherein M is selected from Fe, Co, or any combination thereof.

In some embodiments, the cathode comprises a sodium ion-conducting material. For example, the sodium ion-conducting material may be Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, or any composite material (e.g., composites with carbon black) thereof (e.g., Na_{2/3}Fe_{1/2}Mn_{1/2}O₂@graphene composite).

In some embodiments, the cathode layer comprises a magnesium ion-conducting material. For example, the magnesium ion-conducting material may be doped manganese oxide (e.g., MgₓMnO_{2.y}H₂O).

In some embodiments, the cathode layer comprises an organic sulfide or a polysulfide. For example, the organic sulfide or polysulfide may be carbynepolysulfide and copolymerized sulfur.

In some embodiments, the cathode layer comprises an air electrode. For example, the air electrode may be large surface area carbon particles (e.g., Super P (i.e., a conductive carbon black)) and catalyst particles (e.g., alpha-MnO₂ nanorods) bound in a mesh (e.g., a polymer binder such as PVDF binder).

In some embodiments, the battery cell further comprises a catholyte (e.g., a liquid catholyte) disposed in the cathode layer. In such embodiments, the seal is substantially impervious to the cathode layer. The catholyte may comprise any material suitable for promoting liquid-solid contact and/or providing an improved interface for ion transfer. For example, the catholyte may comprise comprises a lithium salt, a linear carbonate, a cyclic carbonate, an ionic liquid, or any combination thereof. For example, the catholyte may comprise a mixture of lithium bis(fluorosulfonyl)imide and N-propyl-N-methylpyrrolidinium bis(fluorosulfonyl)imide. In other embodiments, the catholyte comprises or a mixture of lithium hexafluorophosphate, ethylene carbonate, and ethyl methyl carbonate.

In some embodiments, the cathode layer has a thickness of from about 1 μm to about 500 μm. In some embodiments, the cathode layer has a thickness of from about 1 μm to about 200 μm. In other embodiments, the cathode layer has a thickness of from about 1 μm to about 100 μm. In some embodiments, the cathode layer has a thickness of from about 1 μm to about 50 μm. In some embodiments, the cathode layer has a thickness of from about 1 μm to about 20 μm. In some embodiments, the cathode layer has a thickness of from about 10 μm to about 150 μm. In other embodiments, the cathode layer has a thickness of from about 40 μm to about 100 μm. And, in some embodiments, the cathode layer has a thickness of from about 60 μm to about 80 μm.

### B. Cathode Current Collector

The cathode current collector is coupled to the cathode layer. With reference again to FIG. 9A the cathode current collector is coupled to the second surface of the cathode layer. In some embodiments, the cathode current collector has an interior surface 966 facing the cathode layer, an exterior surface 968 facing away from the cathode layer, and an outer surface 970 extending from the interior surface to the exterior surface.

In some embodiments, the cathode current collector is at least partially disposed on the second surface of the cathode layer. In some embodiments, the cathode current collector is disposed on the entire second surface of the cathode layer. In other embodiments, the cathode current collector is disposed on substantially all (e.g., at least 60%, at least 70%, at least 80%, at least 90%, or at least 95%) of the second surface of the cathode layer. And, in other embodiments, the cathode current collector is disposed only on a portion of the second surface of the cathode layer.

In some embodiments, the cathode current collector comprises a metal foil 972, as shown in FIGS. 9A and 9B. In such embodiments, the metal foil 972 is at least partially disposed on the second surface 968 of the cathode layer 956. In some embodiments, the metal foil is disposed on the entire second surface of the cathode layer. In other embodiments, the metal foil is disposed on substantially all (e.g., at least 60%, at least 70%, at least 80%, at least 90%, or at least 95%) of the second surface of the cathode layer. And, in other embodiments, the metal foil is disposed only on a portion of the second surface of the cathode layer.

In some embodiments, the metal foil has a tab 974 configured to connect with an external circuit, as shown in FIG. 9B. In the illustrated embodiment, the tab is integral with the metal foil. In other embodiments, the tab is coupled (e.g., welded) to the metal foil.

The cathode current collector may be comprised of any suitable material. In some embodiments, the cathode current collector (e.g., the metal foil and/or the tab) comprises aluminum, stainless steel, alloys thereof, or any combination thereof. In some embodiments, the cathode current collector comprises aluminum. In some embodiments, the cathode current collector comprises an aluminum alloy. In other embodiments, the cathode current collector comprises stainless steel. And, in some embodiments, the cathode current collector comprises a stainless steel alloy.

In some embodiments, the cathode current collector comprises an electronically conductive film. For example, the electronically conductive film may comprise a polymer material and a conductive material. For example, the conductive material may be a metal material. In some embodiments, the conductive material comprises aluminum, stainless steel, alloys thereof, or any combination thereof.

In some embodiments, electronically conductive tape couples the cathode current collector to the cathode layer. During operation of the battery cell (e.g., charging and/or discharging of the battery cell), the electronically conductive tape may electrically couple the cathode current collector to the cathode layer.

In some embodiments, the cathode current collector 972 defines an aperture 976 configured to permit filling of the cathode layer with a catholyte, as shown in FIGS. 9A and 9B. In the illustrated embodiment, the exterior surface 968 of the cathode current collector defines the aperture configured to permit filling of the cathode layer with a catholyte. In other embodiments, the outer surface and the exterior surface of the cathode current collector define the aperture 1076′ configured to permit filling of the cathode layer with a catholyte, as shown in FIGS. 10C and 10D. In the embodiments of FIGS. 9A-D and 10A-D, it will be appreciated that when the seal is impervious to liquid and gas (i.e., the barrier is the seal), the anode layer remains hermetically sealed from the environment outside of the cathode current collector.

In some embodiments, a cross-sectional width of the cathode current collector is greater than a cross-sectional width of the cathode layer, as shown in FIGS. 8A, 9A, and 10A. In other embodiments, a cross-sectional width of the cathode current collector is substantially the same as a cross-sectional width of the cathode layer, as shown in FIGS. 8C and 9C.

### C. Barrier

The barrier is impervious to liquid and gas. The barrier may be any barrier described herein (e.g., any seal described herein and/or any housing described herein).

In some embodiments, the barrier is at least partially disposed on the cathode layer. For example, the barrier (e.g., seal) may be at least partially disposed on the outer surface of the cathode layer, as shown in FIGS. 9A, 9C, 10A, and 10C. In the illustrated embodiments, the barrier is disposed on the entire outer surface of the cathode layer. In other embodiments, the barrier is disposed on substantially all (e.g., at least 60%, at least 70%, at least 80%, at least 90%, or at least 95%) of the outer surface of the cathode layer. And, in some embodiments, the barrier is disposed only on a portion of the outer surface of the cathode layer.

In some embodiments, the barrier is at least partially disposed on the cathode current collector. For example, the barrier (e.g., seal) may be at least partially disposed on the outer surface of the cathode current collector, as shown in FIGS. 9C and 10C. In other embodiments, the barrier is disposed on substantially all (e.g., at least 60%, at least 70%, at least 80%, at least 90%, or at least 95%) of the outer surface of the cathode current collector. And, in some embodiments, the barrier is disposed only on a portion of the outer surface of the cathode current collector.

In some embodiments, the barrier (e.g., seal) is at least partially disposed on the interior surface of the cathode current collector, as shown in FIGS. 9A and 10A. In other embodiments, the barrier is disposed on substantially all (e.g., at least 60%, at least 70%, at least 80%, at least 90%, or at least 95%) of the interior surface of the cathode current collector. And, in some embodiments, the barrier is disposed only on a portion of the interior surface of the cathode current collector, as shown in FIGS. 9A and 10A.

In some embodiments, the barrier is at least partially disposed on each of the outer surface of the anode layer, the outer surface of the separator layer, and the interior surfaces of the anode and cathode current collectors. For example, the barrier (e.g., seal) may be disposed on the entire outer surface of the anode layer, the entire outer surface of the separator layer, and only a portion the interior surfaces of the anode current collector and the cathode current collector, as shown in FIGS. 9A and 10A.

In some embodiments, the barrier (e.g., seal) may be at least partially disposed on each of the outer surface of the anode layer, the outer surface of the separator layer, the interior surface of the cathode current collector, and the outer and exterior surfaces of the anode current collector, as shown in FIG. 8A. In the illustrated embodiment, the barrier is disposed on the entire outer surface of the anode layer, the entire outer surface of the separator layer, only a portion of the interior surface of the cathode current collector, and the entire outer and exterior surfaces of the anode current collector.

In some embodiments, the barrier is at least partially disposed on each of the outer surface of the anode layer, the outer surface of the separator layer, the outer surface of the cathode layer, and the interior surfaces of the anode and cathode current collectors. For example, the barrier (e.g., seal) may be disposed on the entire outer surface of the anode layer, the entire outer surface of the separator layer, the entire outer surface of the cathode layer, and only a portion the interior surfaces of the anode current collector and the cathode current collector, as shown in FIGS. 9A and 10A.

In some embodiments, the barrier may be at least partially disposed on each of the outer surface of the anode layer, the outer surface of the separator layer, the outer surface of the cathode layer, the interior surface of the cathode current collector, and the outer and exterior surfaces of the anode current collector. For example, the barrier (e.g., seal) may be disposed on the entire outer surface of the anode layer, the entire outer surface of the separator layer, the entire outer surface of the cathode layer, only a portion of the interior surface of the cathode current collector, and the entire outer and exterior surfaces of the anode current collector, as shown in FIG. 8A.

In some embodiments, the barrier (e.g., seal) may be at least partially disposed on each of the outer surface of the anode layer, the outer surface of the separator layer, the outer surface of the cathode layer, the outer surface of the cathode current collector, and the outer and exterior surfaces of the anode current collector, as shown in FIG. 8C. In the illustrated embodiment, the barrier is disposed on the entire outer surface of the anode layer, the entire outer surface of the separator layer, the entire outer surface of the cathode layer, the entire outer surface of the cathode current collector, and the entire outer and exterior surfaces of the anode current collector.

In some embodiments, the barrier may be at least partially disposed on each of the outer surface of the anode layer, the outer surface of the separator layer, the outer surface of the cathode layer, the outer surface of the cathode current collector, and the interior surface of the anode current collector. For example, the barrier (e.g., seal) may be disposed on the entire outer surface of the anode layer, the entire outer surface of the separator layer, the entire outer surface of the cathode layer, the entire outer surface of the cathode current collector, and only a portion of the interior surface of the anode current collector, as shown in FIG. 9C.

In some embodiments, the barrier is at least partially disposed on the anode layer and the separator layer. In other embodiments, the barrier is at least partially disposed on the anode layer and the anode current collector. And, in some embodiments, the barrier is at least partially disposed on the anode layer, the anode current collector, and the separator layer.

In some embodiments, the battery cell further comprises a housing. The housing may be any housing described herein. In some embodiments, the barrier is the housing. In other embodiments, the housing is substantially impervious to liquid and pervious to gas. When the housing is present, the separator layer, the anode layer, the anode current collector, the cathode layer, the cathode current collector, and/or the seal may be disposed in the interior of the housing.

In some embodiments, the battery cell is free of a component applying a substantial mechanical force on one or more of the anode layer, the separator layer, the seal, the anode current collector, the cathode layer, and the cathode current collector.

In one aspect, the present invention provides a battery cell. The battery cell comprises a separator layer, an anode layer, an anode current collector, a cathode layer, and a cathode current collector. The separator layer has a front surface facing the anode layer, a back surface facing away from the anode layer, and an outer surface extending from the front surface to the back surface. The anode layer is at least partially disposed on the front surface of the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The anode current collector is coupled to the second surface of the anode layer. The cathode layer is at least partially disposed on the back surface of the separator layer. The cathode current collector is coupled to the second surface of the cathode layer. And, an absolute pressure within the pores, Pₚₒᵣₑₛ, is less than an absolute pressure of an environment outside of the anode layer, Pₑₙᵥ.

In another aspect, the present invention provides a battery cell. The battery cell comprises a separator layer, an anode layer, an anode current collector, a cathode layer, a cathode current collector, and a barrier. The separator layer has a front surface facing the anode layer, a back surface facing away from the anode layer, and an outer surface extending from the front surface to the back surface. The anode layer is at least partially disposed on the front surface of the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The anode current collector is coupled to the second surface of the anode layer. The cathode layer is at least partially disposed on the back surface of the separator layer. The cathode current collector is coupled to the second surface of the cathode layer. The barrier is disposed about the outer surface of the anode layer and defines an interior and exterior. The barrier is impervious to liquid and gas. The anode layer is disposed in the interior of the barrier. And, an absolute pressure of the interior, Pᵢₙₜ, of the barrier is less than an absolute pressure of the exterior, Pₑₓₜ, of the barrier.

In a further aspect, the present invention provides a battery cell. The battery cell comprises a separator layer, an anode layer, an anode current collector, a cathode layer, a cathode current collector, and a seal. The separator layer has a front surface facing the anode layer, a back surface facing away from the anode layer, and an outer surface extending from the front surface to the back surface. The anode layer is at least partially disposed on the front surface of the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The anode current collector is coupled to the second surface of the anode layer. The cathode layer is at least partially disposed on the back surface of the separator layer. The cathode current collector is coupled to the second surface of the cathode layer. The seal is disposed about the outer surface of the anode layer and defines an interior and exterior. The seal comprises a sealant material. The seal is impervious to liquid and gas. The anode layer is disposed in the interior of the seal. And, an absolute pressure of the interior, Pᵢₙₜ, of the seal is less than an absolute pressure of the exterior, Pₑₓₜ, of the seal.

In yet another aspect, the present invention provides a battery cell. The battery cell comprises a separator layer, an anode layer, an anode current collector, a cathode layer, a cathode current collector, and a housing. The housing comprises a plurality of interior walls defining an interior and an exterior. The separator layer is disposed in the interior of the housing and has a front surface facing the anode layer, a back surface facing away from the anode layer, and an outer surface extending from the front surface to the back surface. The anode layer is disposed in the interior of the housing and at least partially disposed on the front surface of the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The anode current collector is disposed in the interior of the housing and is coupled to the second surface of the anode layer. The cathode layer is disposed in the interior of the housing and is at least partially disposed on the back surface of the separator layer. The cathode current collector is disposed in the interior of the housing and is coupled to the second surface of the cathode layer. The housing is impervious to liquid and gas. And, an absolute pressure of the interior, Pᵢₙₜ, of the housing is less than an absolute pressure of the exterior, Pₑₓₜ, of the housing.

In another aspect, the present inventions provides a battery cell. The battery cell comprises a housing, a separator, an anode layer, an anode current collector, a cathode layer, a cathode current collector, and a seal. The housing comprises a plurality of interior walls defining an interior and an exterior. The separator layer is disposed in the interior of the housing and has a front surface facing the anode layer, a back surface facing away from the anode layer, and an outer surface extending from the front surface to the back surface. The anode layer is disposed in the interior of the housing and is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The cathode layer is disposed in the interior of the housing and is at least partially disposed on the back surface of the separator layer. The cathode current collector is disposed in the interior of the housing and is coupled to the second surface of the cathode layer. The seal is disposed in the interior of the housing and is disposed about the outer surface of the anode layer. The seal defines an interior and exterior. The seal comprises a sealant material. The seal is impervious to liquid and gas. The anode layer is disposed in the interior of the seal. And, an absolute pressure of the interior, Pᵢₙₜ, of the seal is less than an absolute pressure of the exterior, Pₑₓₜ, of the seal.

In a further aspect, the present inventions provides a battery cell. The battery cell comprises a housing, a separator, an anode layer, an anode current collector, a cathode layer, a cathode current collector, and a seal. The housing comprises a plurality of interior walls defining an interior and an exterior. The separator layer is disposed in the interior of the housing and has a front surface facing the anode layer, a back surface facing away from the anode layer, and an outer surface extending from the front surface to the back surface. The anode layer is disposed in the interior of the housing and is at least partially disposed on the separator layer. The anode layer has a first surface facing the separator layer, a second surface facing away from the separator layer, and an outer surface extending from the first surface to the second surface. The anode layer comprises a solid-state electrolyte (SSE) material defining pores adapted to receive an anode material. The cathode layer is disposed in the interior of the housing and is at least partially disposed on the back surface of the separator layer. The cathode current collector is disposed in the interior of the housing and is coupled to the second surface of the cathode layer. The seal is disposed in the interior of the housing and is disposed about the outer surface of the anode layer. The seal defines an interior and exterior. The seal comprises a sealant material. The seal is substantially impervious to liquid and pervious to gas. The anode layer is disposed in the interior of the seal. The housing is impervious to liquid and gas. And, an absolute pressure of the interior, Pᵢₙₜ, of the housing is less than an absolute pressure of the exterior, Pₑₓₜ, of the housing.

### IV. METHODS OF FORMING AN ANODE ASSEMBLY

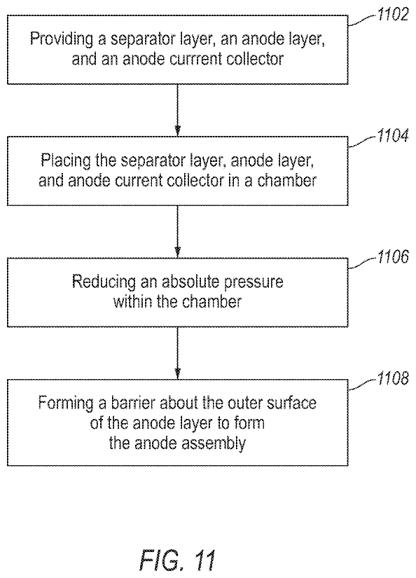

Another aspect of the present invention provides a method of forming an anode assembly. With reference to FIG. 11, a flow chart depicting an exemplary implementation of forming an anode assembly for a battery cell is provided. The method comprises:
(a) providing:
   a separator layer,
   an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) material defining pores adapted to receive an anode material, and
   an anode current collector coupled to the second surface of the anode layer (1102); and
(b) placing the separator layer, anode layer, and anode current collector in a chamber (1104);
(c) reducing an absolute pressure within the chamber thereby reducing an absolute pressure within the pores of the anode layer, Pₚₒᵣₑₛ (1106); and
(d) forming a barrier about the outer surface of the anode layer after step (c) to form the anode assembly, wherein the barrier defines an interior and exterior, wherein the anode layer is disposed in the interior of the interior, and wherein the barrier is substantially impervious to liquid and gas (1108).

In some implementations, step (c) further comprises reducing the absolute pressure within the chamber with a vacuum pump.

In some implementations, Pₚₒᵣₑₛ is less than about 101,325 Pa after step (c). For example, Pₚₒᵣₑₛ may be from about 1 Pa to about 101,324 Pa after step (c). In some implementations, Pₚₒᵣₑₛ is from about 100 Pa to about 1,000 Pa after step (c). In some implementations, Pₚₒᵣₑₛ is from about 100 Pa to about 200 Pa after step (c). In other implementations, Pₚₒᵣₑₛ is from about 200 Pa to about 300 Pa after step (c). In some implementations, Pₚₒᵣₑₛ is from about 300 Pa to about 400 Pa after step (c). In some implementations, Pₚₒᵣₑₛ is from about 400 Pa to about 500 Pa after step (c). In other implementations, Pₚₒᵣₑₛ is from about 500 Pa to about 600 Pa after step (c). In some implementations, Pₚₒᵣₑₛ is from about 600 Pa to about 700 Pa after step (c). In other implementations, Pₚₒᵣₑₛ is from about 700 Pa to about 800 Pa after step (c). In some implementations, Pₚₒᵣₑₛ is from about 800 Pa to about 900 Pa after step (c). In some implementations, Pₚₒᵣₑₛ is from about 900 Pa to about 1,000 Pa after step (c). In some implementations, Pₚₒᵣₑₛ is from about 100 Pa to about 500 Pa after step (c). In some implementations, Pₚₒᵣₑₛ is from about 500 Pa to about 1,000 Pa after step (c). And, in some implementations, Pₚₒᵣₑₛ is from about 250 Pa to about 750 Pa after step (c).

In some implementations, Pₚₒᵣₑₛ is from about 100 Pa to about 2,000 Pa after step (c). In other implementations, Pₚₒᵣₑₛ is from about 200 Pa to about 1,800 Pa after step (c). In some implementations, Pₚₒᵣₑₛ is from about 300 Pa to about 1,700 Pa after step (c). In some implementations, Pₚₒᵣₑₛ is from about 400 Pa to about 1,600 Pa after step (c). In some implementations, Pₚₒᵣₑₛ is from about 500 Pa to about 1,500 Pa after step (c). In other implementations, Pₚₒᵣₑₛ is from about 600 Pa to about 1,400 Pa after step (c). In some implementations, Pₚₒᵣₑₛ is from about 700 Pa to about 1,300 Pa after step (c). In some implementations, Pₚₒᵣₑₛ is from about 750 Pa to about 1,250 Pa after step (c). In other implementations, Pₚₒᵣₑₛ is from about 800 Pa to about 1,200 Pa after step (c). In some implementations, Pₚₒᵣₑₛ is from about 850 Pa to about 1,150 Pa after step (c). In other implementations, Pₚₒᵣₑₛ is from about 900 Pa to about 1,100 Pa after step (c). And, in some implementations, Pₚₒᵣₑₛ is from about 1,000 Pa after step (c).

In some implementations, Pₚₒᵣₑₛ is from about 1,000 Pa to about 10,000 Pa after step (c). For example, Pₚₒᵣₑₛ may be from about 1,000 Pa to about 2,000 Pa after step (c). In some implementations, Pₚₒᵣₑₛ is from about 2,000 Pa to about 3,000 Pa after step (c). In other implementations, Pₚₒᵣₑₛ is from about 3,000 Pa to about 4,000 Pa after step (c). In some implementations, Pₚₒᵣₑₛ is from about 4,000 Pa to about 5,000 Pa after step (c). In some implementations, Pₚₒᵣₑₛ is from about 5,000 Pa to about 6,000 Pa after step (c). In other implementations, Pₚₒᵣₑₛ is from about 6,000 Pa to about 7,000 Pa after step (c). In some implementations, Pₚₒᵣₑₛ is from about 7,000 Pa to about 8,000 Pa after step (c). In some implementations, Pₚₒᵣₑₛ is from about 8,000 Pa to about 9,000 Pa after step (c). In other implementations, Pₚₒᵣₑₛ is from about 9,000 Pa to about 10,000 Pa after step (c). In some implementations, Pₚₒᵣₑₛ is from about 1,000 Pa to about 5,000 Pa after step (c). In some implementations, Pₚₒᵣₑₛ is from about 5,000 Pa to about 10,000 Pa after step (c). And, in some implementations, Pₚₒᵣₑₛ is from about 2,500 Pa to about 7,500 Pa after step (c).

In some implementations, Pₚₒᵣₑₛ is from about 10,000 Pa to about 101,324 Pa after step (c). For example, Pₚₒᵣₑₛ may be from about 10,000 Pa to about 20,000 Pa after step (c). In some implementations, Pₚₒᵣₑₛ is from about 20,000 Pa to about 30,000 Pa after step (c). In other implementations, Pₚₒᵣₑₛ is from about 30,000 Pa to about 40,000 Pa after step (c). In some implementations, Pₚₒᵣₑₛ is from about 40,000 Pa to about 50,000 Pa after step (c). In some implementations, Pₚₒᵣₑₛ is from about 50,000 Pa to about 60,000 Pa after step (c). In some implementations, Pₚₒᵣₑₛ is from about 60,000 Pa to about 70,000 Pa after step (c). In some implementations, Pₚₒᵣₑₛ is from about 70,000 Pa to about 80,000 Pa after step (c). In other implementations, Pₚₒᵣₑₛ is from about 80,000 Pa to about 90,000 Pa after step (c). In some implementations, Pₚₒᵣₑₛ is from about 90,000 Pa to about 100,000 Pa after step (c). In some implementations, Pₚₒᵣₑₛ is from about 10,000 Pa to about 50,000 Pa after step (c). In some implementations, Pₚₒᵣₑₛ is from about 50,000 Pa to about 100,000 Pa after step (c). And, in some implementations, Pₚₒᵣₑₛ is from about 25,000 Pa to about 75,000 Pa after step (c).

In some implementations, Pₚₒᵣₑₛ is from about 0.1 Pa to about 100 Pa after step (c). For example, Pₚₒᵣₑₛ may be from about 1 Pa to about 10 Pa after step (c). In some implementations, Pₚₒᵣₑₛ is from about 10 Pa to about 20 Pa after step (c). In other implementations, Pₚₒᵣₑₛ is from about 20 Pa to about 30 Pa after step (c). In some implementations, Pₚₒᵣₑₛ is from about 30 Pa to about 40 Pa after step (c). In other implementations, Pₚₒᵣₑₛ is from about 40 Pa to about 50 Pa after step (c). In some implementations, Pₚₒᵣₑₛ is from about 50 Pa to about 60 Pa after step (c). In some implementations, Pₚₒᵣₑₛ is from about 60 Pa to about 70 Pa after step (c). In some implementations, Pₚₒᵣₑₛ is from about 70 Pa to about 80 Pa after step (c). In other implementations, Pₚₒᵣₑₛ is from about 80 Pa to about 90 Pa after step (c). In some implementations, Pₚₒᵣₑₛ is from about 90 Pa to about 100 Pa after step (c). In some implementations, Pₚₒᵣₑₛ is from about 1 Pa to about 50 Pa after step (c). In other implementations, Pₚₒᵣₑₛ is from about 50 Pa to about 100 Pa after step (c). In some implementations, Pₚₒᵣₑₛ is from about 25 Pa to about 75 Pa after step (c). And, in some implementations, Pₚₒᵣₑₛ is less than about 1 Pa after step (c).

In some implementations, forming step (d) comprises forming a housing impervious to liquid and gas (i.e., the barrier is the housing) about the outer surface of the anode layer after step (c). The housing comprises a plurality of interior walls defining the interior and the exterior. The separator layer, the anode layer, and the anode current collector are disposed in the interior of the housing. In some implementations, step (d) further comprises hermetically sealing the plurality of walls to form the housing. For example, a sealant material may be used to hermetically seal the plurality of walls. The sealant material may be any sealant material described herein.

In other implementations, step (d) comprises forming a seal impervious to liquid and gas (i.e., the barrier is the seal) about the outer surface of the anode layer after step (c) to form the anode assembly. The seal defines the interior and the exterior. The anode layer is disposed in the interior of the seal.

In some implementations, the forming of step (d) comprises forming the seal from a sealant material by cold-pressing, hot-pressing, melting, 3D-printing, or any combination thereof, the sealant material at least partially on the outer surface of the anode layer. In some implementations, the forming of step (d) comprises forming the seal from a sealant material by cold-pressing the sealant material at least partially on the outer surface of the anode layer. In other implementations, the forming of step (d) comprises forming the seal from a sealant material by hot-pressing the sealant material at least partially on the outer surface of the anode layer. In some implementations, the forming of step (d) comprises forming the seal from a sealant material by melting the sealant material at least partially on the outer surface of the anode layer. And, in some implementations, the forming of step (d) comprises forming the seal from a sealant material by 3D-printing the sealant material at least partially on the outer surface of the anode layer.

In some implementations, the forming of step (d) comprises forming the seal from a sealant material by mechanically applying the sealant material at least partially on the outer surface of the anode layer. For example, the forming of step (d) may comprise forming the seal from a sealant material by applying the sealant material at least partially on the outer surface of the anode layer with a paintbrush, a roller, a plastic applicator, a metal applicator, a shaping tool, a syringe dispenser, a dispenser valve, or any combination thereof. In some implementations, the forming of step (d) comprises forming the seal from a sealant material by applying the sealant material at least partially on the outer surface of the anode layer with a paintbrush. In other implementations, the forming of step (d) comprises forming the seal from a sealant material by applying the sealant material at least partially on the outer surface of the anode layer with a roller. In some implementations, the forming of step (d) comprises forming the seal from a sealant material by applying the sealant material at least partially on the outer surface of the anode layer with a plastic applicator. In some implementations, the forming of step (d) comprises forming the seal from a sealant material by applying the sealant material at least partially on the outer surface of the anode layer with a metal applicator. In other implementations, the forming of step (d) comprises forming the seal from a sealant material by applying the sealant material at least partially on the outer surface of the anode layer with a shaping tool. In some implementations, the forming of step (d) comprises forming the seal from a sealant material by applying the sealant material at least partially on the outer surface of the anode layer with a syringe dispenser. And, in some implementations, the forming of step (d) comprises forming the seal from a sealant material by applying the sealant material at least partially on the outer surface of the anode layer with a dispenser valve.

In some implementations, the forming of step (d) comprises forming the seal from a sealant material by injection molding, in-line extrusion, spray deposition, 3D-printing, wrapping, or any combination thereof, the sealant material at least partially on the outer surface of the anode layer. In some implementations, the forming of step (d) comprises forming the seal from a sealant material by injection molding the sealant material at least partially on the outer surface of the anode layer. In other implementations, the forming of step (d) comprises forming the seal from a sealant material by in-line extrusion of the sealant material at least partially on the outer surface of the anode layer. In some implementations, the forming of step (d) comprises forming the seal from a sealant material by spray deposition of the sealant material at least partially on the outer surface of the anode layer. In some implementations, the forming of step (d) comprises forming the seal from a sealant material by 3D-printing of the sealant material at least partially on the outer surface of the anode layer. And, in some implementations, the forming of step (d) comprises forming the seal from a sealant material by wrapping the sealant material at least partially on the outer surface of the anode layer.

The temperature and/or application pressure of the sealant material may be selected to provide suitable sealant material flow and coverage, without damage to the other components of the anode assembly. In implementations where the sealant material is at least partially disposed on the outer surface of the anode layer and in the pores of the second porous region, the temperature and/or application pressure of the sealant material may be sufficient to allow for the desired level of infiltration of the pores of the second porous region. Likewise, the location of the sealant material, volume of the sealant material, and rate of application the sealant material, as well as any cooling regime for the seal, may be adjusted for each particular embodiment of the seal.

The sealant material may be any sealant material described herein. For example, the sealant material may comprise polypropylene, polyethylene, polyimide, polyvinyl chloride (PVC), ethylene-vinyl acetate, polyamide, polypropylene, polyurethane, copolymers thereof, or any combination thereof. For example, the sealant material may comprise polypropylene. In some implementations, the sealant material comprises polyethylene. In other implementations, the sealant material comprises polyimide. In some implementations, the sealant material comprises PVC. In some implementations, the sealant material comprises ethylene-vinyl acetate. In other implementations, the sealant material comprises polyamide. In some implementations, the sealant material comprises polypropylene. And, in some implementations, the sealant material comprises polyurethane.

In some implementations, the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. In some implementations, the sealant material comprises polypropylene. In some implementations, the sealant material comprises polyethylene. In other implementations, the sealant material comprises polymethylpentene. In some implementations, the sealant material comprises polybutene-1. In some implementations, the sealant material comprises ethylene-octene copolymers. In some implementations, the sealant material comprises propylene-butane copolymers. In some implementations, the sealant material comprises polyisobutylene. In some implementations, the sealant material comprises poly(α-olefin). In some implementations, the sealant material comprises ethylene propylene rubber. In other implementations, the sealant material comprises ethylene propylene diene monomer rubber. In some implementations, the sealant material comprises ethylene-vinyl acetate. In some implementations, the sealant material comprises ethylene-acrylate copolymers. In other implementations, the sealant material comprises polyamides. In some implementations, the sealant material comprises polyesters. In some implementations, the sealant material comprises polyurethanes. In some implementations, the sealant material comprises styrene block copolymers. In some implementations, the sealant material comprises polycaprolactone. In other implementations, the sealant material comprises polyimide. In some implementations, the sealant material comprises polyvinyl chloride. In some implementations, the sealant material comprises polycarbonates. In some implementations, the sealant material comprises polyacrylates. In some implementations, the sealant material comprises polymethacrylates. In some implementations, the sealant material comprises fluoropolymers. In some implementations, the sealant material comprises epoxy resins. In other implementations, the sealant material comprises epoxy polymers. And, in some implementations, the sealant material comprises silicone rubber.

In some implementations, the forming of step (d) further comprises curing the sealant material. For example, curing the sealant material may comprise curing the sealant material by exposure to radiation (e.g., ultraviolet (UV) radiation). In some implementations, curing may be performed with UV radiation from a UV lamp. In other implementations, curing the sealant material comprises epoxy curing.

In some implementations, forming step (d) is performed in the chamber. In other implementations, the chamber may be further defined as a first chamber, and forming step (d) may be performed in a second chamber. In such implementations, an absolute pressure within the second chamber may be substantially the same as the absolute pressure within the first chamber to ensure that Pₚₒᵣₑₛ is substantially maintained between steps (c) and (d).

In some implementations, when step (d) is performed in the chamber, the method further comprises (e) removing the anode assembly from the chamber. In other implementations, when step (d) is performed in a second chamber, the method further comprises (e) removing the anode assembly from the second chamber.

In another aspect, the present invention provides a method of forming an anode assembly for a battery cell. The method comprises
(a-1) providing:
   a separator layer,
   an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) material defining pores adapted to receive an anode material, and
   an anode current collector; and
(b-1) placing the separator layer, anode layer, and anode current collector in a chamber;
(c-1) reducing an absolute pressure within the chamber thereby reducing an absolute pressure within the pores of the anode layer, Pₚₒᵣₑₛ; and
(d-1) forming a barrier about the outer surface of the anode layer after step (c), wherein the barrier defines an interior and exterior, wherein the anode layer is disposed in the interior of the interior, and wherein the barrier is substantially impervious to liquid and gas; and
(e-1) coupling the anode current collector to the second surface of the anode layer.

In some implementations, step (e-1) is performed prior to step (d-1). In other implementations, step (d-1) is performed prior to step (e-1).

In another aspect, the present invention provides a method of forming an anode assembly for a battery cell. The method comprises
(a-2) providing:
   a separator layer,
   an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) material defining pores adapted to receive an anode material, and
   an anode current collector coupled to the second surface of the anode layer; and
(b-2) placing the separator layer, anode layer, and anode current collector in a chamber;
(c-2) reducing an absolute pressure within the chamber thereby reducing an absolute pressure within the pores of the anode layer, Pₚₒᵣₑₛ; and
(d-2) forming a seal about the outer surface of the anode layer after step (c) to form the anode assembly, wherein the seal defines an interior and exterior, wherein the anode layer is disposed in the interior of the seal, and wherein the seal is impervious to liquid and gas.

In another aspect, the present invention provides a method of forming an anode assembly for a battery cell. The method comprises
(a-3) providing:
   a separator layer,
   an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) material defining pores adapted to receive an anode material, and
   an anode current collector coupled to the second surface of the anode layer; and
(b-3) placing the separator layer, anode layer, and anode current collector in a chamber;
(c-3) reducing an absolute pressure within the chamber thereby reducing an absolute pressure within the pores of the anode layer, Pₚₒᵣₑₛ; and
(d-3) forming a seal about the outer surface of the anode layer after step (c), wherein the seal defines an interior and exterior, wherein the anode layer is disposed in the interior of the seal, and wherein the seal is impervious to liquid and gas;
(e-3) coupling the anode current collector to the second surface of the anode layer.

In some implementations, step (e-3) is performed prior to step (d-3). In other implementations, step (d-3) is performed prior to step (e-3).

### V. EXAMPLES

In order that the invention described herein may be more fully understood, the following examples are set forth. The examples described in this application are offered to illustrate the methods and anode assemblies provided herein and are not to be construed in any way as limiting their scope.

### Example 1: Anode Assembly

A separator layer and an anode layer at least partially disposed on the separator layer will be provided. The anode layer will comprise a solid-state electrolyte (SSE) material defining pores adapted to receive an anode material. An anode current collector will also be provided. The bilayer (i.e., the separator layer and the anode layer) and the anode current collector will be placed in a glovebox. An absolute pressure within the glovebox (e.g., an MBraun glovebox) will be set based on a desired absolute pressure within the pores of the anode layer (e.g., less than about 101,324 Pa).

Once the absolute pressure within the pores of the anode layer is substantially the same as the absolute pressure within the glovebox, the anode current collector will be coupled to the surface of the anode layer facing away from the separator layer with an adhesive (e.g., an electronically conductive adhesive material (e.g., an electronically conductive tape)). A sealant material that is impervious to liquid and gas will then be applied to an outer surface of the anode layer (i.e., a surface extending between the surface coupled to the anode current collector and the surface disposed on the separator layer) to form a seal. The seal, in cooperation with the separator layer and anode current collector, will likely ensure that that the absolute pressure within the pores of the anode layer remains substantially the same as the absolute pressure within the glovebox after removal of the anode assembly from the glovebox.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims.

Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

1-81. (canceled)

82. An anode assembly for a battery cell, comprising:
a separator layer;
an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) material defining pores adapted to receive an anode material, and wherein an absolute pressure within the pores, Pₚₒᵣₑₛ, is less than an absolute pressure of an environment outside of the anode layer, Pₑₙᵥ.

83. The anode assembly of claim 82, wherein Pₚₒᵣₑₛ is less than about 101,325 Pa.

84. The anode assembly of claim 83, wherein Pₚₒᵣₑₛ is from about 1 Pa to about 101,324 Pa.

85. The anode assembly of claim 82, wherein a pressure differential between Pₚₒᵣₑₛ and Pₑₙᵥ is from about 100 Pa to about 100,000 Pa.

86. The anode assembly of claim 85, wherein the pressure differential between Pₚₒᵣₑₛ and Pₑₙᵥ is from about 1,000 Pa to about 100,000 Pa.

87. The anode assembly of claim 83, wherein the separator layer is substantially free of pores.

88. The anode assembly of claim 87, wherein the separator layer comprises a SSE material.

89. The anode assembly of claim 88, wherein the SSE material of the separator layer comprises a polymer, a sulfide, an oxide, a chalcogenide, or any combination thereof.

90. The anode assembly of claim 88, wherein the separator layer has a thickness of from about 1 μm to about 300 μm.

91. The anode assembly of claim 88, further comprising an anode material disposed in at least a portion of the pores of the anode layer.

92. The anode assembly of claim 91, wherein the anode material comprises lithium metal, sodium metal, magnesium metal, or any combination thereof.

93. The anode assembly of claim 92, wherein the anode layer comprises a garnet material.

94. The anode assembly of claim 93, wherein the anode layer has a thickness of from about 1 μm to about 500 μm.

95. The anode assembly of claim 93, further comprising an anode current collector coupled to the second surface of the anode layer.

96. The anode assembly of claim 95, wherein the anode current collector comprises a metal foil.

97. An anode assembly for a battery cell, comprising:
a separator layer;
an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) material defining pores adapted to receive an anode material; and
a barrier disposed about the outer surface of the anode layer and defining an interior and exterior, wherein the barrier is impervious to liquid and gas, wherein the anode layer is disposed in the interior of the barrier, and wherein an absolute pressure of the interior, Pᵢₙₜ, is less than an absolute pressure of the exterior, Pₑₓₜ.

98. The anode assembly of claim 97, wherein Pᵢₙₜ is less than about 101,325 Pa.

99. The anode assembly of claim 98, wherein Pᵢₙₜ is from about 1 Pa to about 101,324 Pa.

100. The anode assembly of claim 97, wherein a pressure differential between Pᵢₙₜ and Pₑₓₜ is from about 100 Pa to about 100,000 Pa.

101. The anode assembly of claim 100, wherein the separator layer is disposed in the interior of the barrier.

102. The anode assembly of claim 101, wherein the separator layer is substantially free of pores.

103. The anode assembly of claim 102, wherein the separator layer comprises a SSE material.

104. The anode assembly of claim 103, wherein the SSE material of the separator layer comprises a polymer, a sulfide, an oxide, a chalcogenide, or any combination thereof.

105. The anode assembly of claim 104, wherein the separator layer has a thickness of from about 1 μm to about 300 μm.

106. The anode assembly of claim 103, further comprising an anode material disposed in at least a portion of the pores of the anode layer.

107. The anode assembly of claim 106, wherein the anode material comprises lithium metal, sodium metal, magnesium metal, or any combination thereof.

108. The anode assembly of claim 107, wherein the anode layer comprises a garnet material.

109. The anode assembly of claim 108, wherein the anode layer has a thickness of from about 1 μm to about 500 μm.

110. The anode assembly of claim 108, further comprising an anode current collector coupled to the second surface of the anode layer.

111. The anode assembly of claim 110, wherein the anode current collector is disposed in the interior of the barrier.

112. The anode assembly of claim 111, wherein the barrier is a seal, and wherein the seal comprises a sealant material.

113. The anode assembly of claim 112, wherein the seal is at least partially disposed on the anode current collector.

114. The anode assembly of claim 112, wherein the seal is at least partially disposed on the outer surface of the anode layer.

115. The anode assembly of claim 112, wherein the seal is at least partially disposed on the separator layer.

116. The anode assembly of claim 115, wherein the separator layer has a front surface facing the anode layer, a back surface facing away from the anode layer, and an outer surface extending from the front surface to the back surface.

117. The anode assembly of claim 116, wherein the seal is at least partially disposed on the outer surface of the separator layer.

118. The anode assembly of any one of claim 115, wherein the separator layer defines a recess, and wherein the seal is disposed in the recess of the separator layer.

119. The anode assembly of any one of claim 114, wherein the anode layer defines a first porous region between a center and the outer surface of the anode layer and a second porous region between the first porous region and the outer surface of the anode layer.

120. The anode assembly of claim 119, wherein the pores for the first porous region are substantially free of the sealant material.

121. The anode assembly of claim 120, wherein at least a portion of the pores of the second porous region comprise the sealant material.

122. The anode assembly of claim 121, further comprising an anode current collector coupled to the second surface of the anode layer;
wherein the separator layer has a front surface facing the anode layer, a back surface facing away from the anode layer, and an outer surface extending from the front surface to the back surface, and wherein the anode current collector has an interior surface facing the anode layer, an exterior surface facing away from the anode layer, and an outer surface extending from the interior surface to the exterior surface; and
wherein the seal is at least partially disposed on each of the outer surface of the anode layer, the outer surface of the separator layer, and the outer surface of the anode current collector.

123. The anode assembly of claim 122, wherein the sealant material comprises a non-conductive polymer, a non-conductive glass, or any combination thereof.

124. The anode assembly of claim 123, wherein the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

125. The anode assembly of claim 124, wherein at least a portion of the seal has a thickness of from about 1 μm to about 50 μm.

126. A battery cell, comprising:
the anode assembly of claim 82;
an anode current collector coupled to the second surface of the anode layer;
a cathode layer at least partially disposed on the separator layer and having a first surface facing the separator layer, a second surface facing away from the separator layer, and an outer surface extending from the first surface to the second surface; and
a cathode current collector coupled to the second surface of the cathode layer.

127. The battery cell of claim 126, further comprising a housing having a plurality of interior walls defining an interior, wherein the anode assembly, anode current collector, cathode layer, and cathode current collector are disposed in the interior of the housing.

128. The battery cell of claim 127, further comprising a catholyte disposed in the cathode layer.

129. A method of forming an anode assembly, comprising:
(a) providing:
a separator layer,
an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) material defining pores adapted to receive an anode material, and
an anode current collector coupled to the second surface of the anode layer;
(b) placing the separator layer, anode layer, and anode current collector in a chamber;
(c) reducing an absolute pressure within the chamber thereby reducing an absolute pressure within the pores of the anode layer, Pₚₒᵣₑₛ; and
(d) forming a barrier about the outer surface of the anode layer after step (c) to form the anode assembly, wherein the barrier defines an interior and exterior, wherein the anode layer is disposed in the interior of the barrier, and wherein the barrier is impervious to liquid and gas.

130. The method of claim 129, wherein Pₚₒᵣₑₛ is less than about 101,325 Pa after step (c).

131. The method of claim 130, wherein Pₚₒᵣₑₛ is from about 1 Pa to about 101,324 Pa after step (c).

132. The method of claim 131, wherein the barrier is a seal, and wherein the forming of step (d) comprises forming the seal from a sealant material by cold-pressing, hot-pressing, melting, 3D-printing, or any combination thereof, the sealant material at least partially on the outer surface of the anode layer.

133. The method of claim 131, wherein the barrier is a seal, and wherein forming of step (d) comprises forming the seal from a sealant material by applying the sealant material at least partially on the outer surface of the anode layer with a paintbrush, a roller, a plastic applicator, a metal applicator, a shaping tool, a syringe dispenser, a dispenser valve, or any combination thereof.

134. The method of claim 131, wherein the sealant material is a polymer, and wherein the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.
